(19) United States
(12) Patent Application Publication
(10) Pub. No.: US 2005/0108520 A1
(43) Pub. Date: May 19, 2005

(54) Authentication apparatus and method, network system, recording medium and computer program

(75) Inventors: Tatsuyoshi Yamamoto, Soka-shi (JP); Hideo Miyamaki, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/007,446

(22) Filed: Dec. 9, 2004

Related U.S. Application Data
(63) Continuation of application No. PCT/JP02/05866, filed on Jun. 12, 2002.

(51) Int. Cl. G06F 11/30

(52) U.S. Cl. 713/155; 713/201

(57) ABSTRACT

An authentication apparatus that makes it difficult to perform posing when accessing information is provided. When there is an access request from a mobile phone, an authentication server transmits a program to the mobile phone (S3202). The program is for reading data regarding an individual number (for example, serial number) recorded in a scratch pad of the mobile phone, and transmitting the data to the authentication server. The authentication server that receives the data regarding the serial number transmitted by activation of the program (S3202) compares the serial number with data regarding the identification number of each mobile phone, the data being maintained in the authentication server (S3203). When the serial number matches any of serial numbers maintained therein (S3203: Yes), the authentication server authenticates the access to be valid.

### CROSS-REFERENCE TO RELATED APPLICATION

This application is a U.S. continuation application, filed under 35 USC 111(a) and claiming the benefit under 35 USC 120 and 365(c), of PCT application PCT/JP2002/005866, filed Jun. 12, 2002. The foregoing application is hereby incorporated herein by reference.

### BACKGROUND OF THE INVENTION

1. Field of the Invention

The present invention relates to, for example, authentication techniques applied when performing information providing services with the use of a user terminal such as a mobile wireless terminal or the like.

2. Description of the Related Art

Information tools (hereinafter referred to as “user terminals”) are widely used, such as a PDA (Personal Digital Assistant) or a notebook computer that allows a user to connect to the Internet with the use of wired/wireless communication means, and a mobile phone having an Internet connection function or an e-mail function. Recently, such user terminals have been generally used as terminals for Internet Mail Service, and computer networks such as the Internet have become actively utilized by, for example, offering information providing services from a server to individual users and performing services for business communications between companies or within a company.

The services as mentioned above are realized such that a server controls communications among user terminals via the Internet and accesses to a specific server involved in the communications.

The services of this kind, using user terminals, are generally provided only to specific users managed by a provider of the services, that is, those who have registered in advance. From such a point of view, when carrying out the services as mentioned above, an authentication procedure is required that confirms whether a person who requests rendering of the services is managed by the service provider.

Generally, authentication is performed by using some authorization information, for example: a user ID such as a user name, and a password. In other words, a user ID and a password sent from a user terminal by a user are compared with user IDs and passwords managed by the service provider. When there is a match, the user is determined to be an authorized user. When there is no match, the user is determined to be an unauthorized user. Only those users who are determined to be authorized users can enjoy predetermined services prepared by the server.

However, such an authentication technique is not free from disadvantages. That is, if a user ID and a password are stolen by a stranger, then the stranger can pose as an authorized user by using them.

An object of the present invention is to provide a novel authentication technique that can positively eliminate the problem of “posing”, which cannot be eliminated by conventional authentication techniques. Another object of the present invention is to provide an applied technology of such an authentication technique.

### SUMMARY OF THE INVENTION

“Posing” occurs since authorization information conventionally used for authentication can be used irrespective of user terminals once it is obtained. To the contrary, if information unique to a user terminal is used and authentication that an access is made by an authorized user is made only when the relevant terminal is used, then it is possible to prevent posing in most cases. The present invention is made based on such perspectives.

The present invention provides an authentication apparatus that authenticates, when a user terminal of a user assigned with predetermined user identification information accesses predetermined information, whether the user terminal is valid based on terminal identification information assigned to each user terminal. The authentication apparatus is configured as follows.

That is, an authentication apparatus according to the present invention includes: user identification information recording means recording the user identification information therein; user identification information determination means for receiving from the user terminal the user identification information of the user using the user terminal, and comparing the received user identification information with user identification information recorded in the user identification information recording means so as to determine whether the received user identification information is valid; terminal identification information generation means for, when the received user identification information is determined to be valid, generating the terminal identification information to be recorded in the user terminal, and transmitting the generated terminal identification information to the user terminal; terminal identification information recording means for recording the terminal identification information; authentication means for comparing the terminal identification information received when the user terminal accesses the predetermined information with the terminal identification information recorded in the terminal identification information recording means so as to determine whether the received terminal identification information is valid; and allowing means for, when the received terminal identification information is valid, the access from the user terminal.

The authentication apparatus can perform a process of issuing unique terminal identification information to each user terminal and a process of performing authentication by using the terminal identification information. That is, information used by the authentication apparatus for authentication is terminal identification information unique to each user terminal. Hence, in the case where a third party intends to pose as another user, it is necessary to obtain a user terminal of the user whom the third party intends to pose as. Accordingly, the authentication apparatus offers higher reliability in authentication than conventional authentication apparatuses.

In addition, when issuing terminal identification information to each user terminal by the authentication apparatus, user identification information unique to each user is used. The terminal identification information is substantially unknowable to users. Hence, according to an authentication apparatus of the present invention, it is possible to significantly reduce the possibility of posing by combining the terminal identification information, which is in principle unknowable to each user, and the user identification information, which is known by each user.

However, the authentication apparatus may be configured to be able to use the user identification information as well as the terminal identification information before performing an authentication process.

It should be noted that “access” in this specification indicates a concept that includes various instructions such as a FAX instruction and a print instruction, in addition to a request for or acquisition of information.

The terminal identification information recording means of the authentication apparatus may record the terminal identification information and area information in pairs, the area information indicating an area of information accessible by a user terminal indicated by each terminal identification information. The allowing means in this case may allow the user terminal to make an access within an area indicated by the area information.

As mentioned above, the area information is information indicating an area of information accessible by a user terminal: for example, information including the address of an access destination registered in advance for each user terminal. With the area information, it is possible to find in authentication what information is being accessed by a user terminal.

The user identification information may be any kind of information as long as the information is unique to each user and allows identification of each user. For example, the user identification information may consist of a pair of an ID and a password assigned to each user.

The above-mentioned area information may be a pair of the above-mentioned address and the user identification information.

In addition, a single pair of an ID and a password may be associated with one set of the user identification information, and the single pair of an ID and a password may be assigned as a general ID and password in the case where there is more than one access destination. The authentication apparatus in this case may further include means for collectively suspending or canceling suspension of use of the general ID and password.

The authentication apparatus according to the present invention may further include: means for maintaining a program for causing the user terminal to be authenticated to transmit the terminal identification information thereof; and means for transmitting the program to the user terminal requesting for authentication. In the aforementioned manner, it is possible for a user terminal having no special function to transmit the terminal identification information to the authentication apparatus.

The above-mentioned program may be a program for causing a user terminal to be authenticated to transmit the terminal identification information thereof in a manner unknowable to a user of the user terminal. The program in this case may self-destruct after the user terminal requesting for authentication transmits the terminal identification information.

The user terminal may include means for recording the program. In this case, the terminal identification information may be transmitted to the authentication apparatus from the user terminal requesting for authentication by a function formed by activating the program recorded in the means for recording the program.

For example, a Java (registered trademark) program may be used for such a program, and JVM (Java virtual Machine) or KVM (compact JVM for mobile terminals such as mobile phones) may be used for an execution environment therefor.

The program may work in collaboration with predetermined hardware installed in a user terminal to realize transmission of the terminal identification information to the authentication apparatus. Additionally, the program may work in collaboration with predetermined hardware installed in a user terminal and a predetermined program installed in the user terminal to realize transmission of the terminal identification information to the authentication apparatus.

A mobile wireless terminal may be used as a user terminal. A mobile wireless terminal includes, for example, a mobile phone, a PHS (Personal Handy-phone System), a PDA using a mobile phone or a PHS, or a notebook computer.

The information which the user terminal desires to access may be record information of a common file that exists in a predetermined network requiring security, and at least a part of which common file is maintained to be common with a file existing outside the network.

The authentication apparatus according to the present invention may further include: means for recording an e-mail address used by each user by associating the e-mail address with the user identification information assigned to each user; means for, when transmitting the terminal identification information to a user, reading an e-mail address assigned to the user from the means for recording an e-mail, and transmitting to the e-mail address an e-mail including information for causing the user to transmit acknowledge information for confirming whether a predetermined process for causing transmission of the terminal identification information is performed by the user; and means for, based on the acknowledge information received from the user who receives the e-mail, determining whether the predetermined process for causing transmission of the terminal identification information is performed by the user, and, performing one of: a process of canceling suspension of use of the general ID and password when it is determined that the transmission of the terminal identification information is based on an action of the user; and a process of suspending the use of the general ID and password when it is determined that the transmission of the terminal identification information is not based on an action of the user.

The authentication apparatus in this case may further include: means for receiving the authentication information transmitted by the user in a form of an e-mail; means for detecting an e-mail address of a transmitting source of the received acknowledge information, and comparing the e-mail address with the e-mail address recorded in the means for recording an e-mail address; and means for performing, as a result of the comparison, one of: a process of canceling suspension of use of the general ID and password when the e-mail addresses match; and a process of suspending the use of the general ID and password when the e-mail addresses do not match.

Additionally, the authentication apparatus according to the present invention may further include: means for recording a telephone number of a mobile phone used by each user by associating the telephone number with the user identification information assigned to each user; means for receiving the authentication information transmitted by the user in a form of communication by telephone; means for detecting a telephone number of a transmitting source of the received acknowledge information, and comparing the telephone number with the telephone number recorded in the means for recording a telephone number; and means for performing, as a result of the comparison, one of: a process of canceling suspension of use of the general ID and password when the telephone numbers match; and a process of suspending the use of the general ID and password when the telephone numbers do not match.

The present invention may also be applied to a network system including: a first server recording information accessible to a user terminal therein; and an authentication apparatus performing authentication as to whether the user terminal that desires to access the information recorded in the first server is valid, the first server being configured to search for relevant information in response to an access from the user terminal determined to be valid and transmit the searched for information to the user terminal that is a source of the access.

The authentication apparatus in this case includes: user identification information recording means recording therein predetermined user identification information assigned to a user in advance; user identification information determination means for receiving from the user terminal the user identification information of the user using the user terminal, and comparing the received user identification information with user identification information recorded in the user identification information recording means so as to determine whether the received user identification information is valid; terminal identification information generation means for, when the received user identification information is determined to be valid, generating the terminal identification information to be recorded in the user terminal, and transmitting the generated terminal identification information to the user terminal; terminal identification information recording means for recording the terminal identification information; authentication means for comparing the terminal identification information received when the user terminal accesses the predetermined information with the terminal identification information recorded in the terminal identification information recording means so as to determine whether the received terminal identification information is valid; and allowing means for, when the received terminal identification information is valid, allowing the access from the user terminal.

The first server may be connected in a network to a second server (server including a common file, at least a part of record information thereof being maintained to be common with that of the first server) that exists outside the network via a private line or a virtual private line.

In this case, the authentication apparatus is configured to perform authentication as to whether the user terminal that desires to access the record information of the common file of the first server is valid.

In a network system in which the first server and the second server are connected to each other, each of the first server and the second server may be configured to transmit, when the record information of the common file thereof is changed, difference data before and after the change to the other server, and when the difference data are received from the other server, automatically perform a replication task that replicates the difference data to the common file thereof.

According to the present invention, it is also possible to realize a configuration in which the number of first servers is more than one, and the second server is provided such that each second server corresponds to one of the first servers.

The authentication apparatus provided in a network system according to the present invention may further include: extracting means for extracting information transmitted from the first server to the user terminal; and transmission information recording means for recording, for each user terminal, data regarding transmission information indicating what information is transmitted.

Alternatively, the authentication apparatus may further include transmission information presenting means for generating data for displaying transmission information with respect to the user terminal on a display of the user terminal based on the data recorded in the transmission information recording means.

With such an authentication apparatus, it is possible to display the transmission information regarding information used by the user on the user terminal in a manner such as an index, which is convenient for the user.

The former network system and the latter network system to which the first server is connected can readily build an environment for realizing groupware (generally, the term groupware indicates computer software that supports operations performed by a group having common tasks or objects; however, in this specification, the term groupware indicates a concept that includes hardware resources for realizing the computer software as well) for each user company.

Forms of business in enterprises have been diversified, and it is rare that business is conducted by a single person. Normally, plural persons perform the activities in a coordinated manner with the use of groupware. Groupware is realized by, for example, connecting multiple user terminals (client terminals) operated by employees and a first server that receives accesses from the user terminals under given conditions to an intranet protected by a firewall, and installing a computer program for forming a user interface function and a security function on the first server.

Normally, a WWW (World Wide Web) server of an Internet provider is connected to the intranet, and e-mails may be received from and transmitted to an external terminal within the intranet via the Internet.

If a server for managing interoffice information is provided in an intranet of an enterprise, and an environment allowing the above-mentioned various terminals to be connected to the server is built, it becomes possible for employees of the enterprise to access the interoffice information at any time and any place, which is highly preferable as an application to business of an enterprise. However, in order to take advantage of the intranet, there are problems as follows.

(1) In an access mode assuming the use of an Internet mail service, there intervenes a WWW server that is operated by a party having no confidentiality. Hence, it is uncertain whether security is ensured to a satisfactory extent.

(2) It is conceivable to connect various terminals to one another all via private circuits, or connect an intranet of the head office of an enterprise and an intranet of each branch office to one another all via private circuits. In this case, however, it is inevitably necessary to lay a number of private circuits, which leads to a sharp increase in the cost for maintaining operations and results in high costs.

(3) Upon using an existing Internet mail service for business, in an Internet mail service normally provided by a mobile phone service provider, there are restrictions according to service conditions set by the provider, for example: the number of characters of a mail; the number of mails that can be stored in a mail server; the forms of attached documents, etc. Hence, it is difficult to transmit a large amount of data. Additionally, in the case of a mobile phone, the operating procedure of a mail function is somewhat different depending on the model of the mobile phone. Hence, it is difficult to realize unified training and proficiency with respect to operations, and thus operationality of groupware is not good.

(4) Conventionally, an enterprise staff member that receives a notice from a mobile phone manually activates an application program corresponding to the contents of the notice, and a computer prepared in a specific service provider using wire communications interprets a control signal that is input from a digital line terminal and automatically activates and executes an application program registered in advance. However, currently, it is not practiced to arbitrarily activate and execute an independently-prepared application program by, for example, a mobile phone without using an existing infrastructure provided by, for example, the above-mentioned service provider. Thus, there are still problems in extensibility of groupware.

Such problems are solved by each of the above-mentioned network systems.

According to the present invention, there is also provided a method of authenticating a user terminal in a network system, wherein an authentication apparatus is provided in a network system in which a first server recording information accessible to a user terminal exists in a predetermined network. The authentication apparatus performs authentication for a user terminal that desires to access the information; records user identification information assigned in advance to a user; receives, from the user terminal requesting for authentication, the user identification information of the user using the user terminal; determines that the user terminal is valid when the received user identification information matches any user identification information that is recorded; generates terminal identification information to be recorded in the user terminal when it is determined that the received user identification information is valid; records and transmits the generated terminal identification information to the user terminal; compares the terminal identification information received when the user terminal accesses predetermined information with the terminal identification information that is already recorded so as to determine whether the received terminal identification information is valid; and when the received terminal identification information is valid, allows the access from the user terminal.

According to the present invention, there is also provided a computer program for causing a computer to perform the following processes. The computer is provided in a network system in which a first server recording information accessible to a user terminal exists in a predetermined network. The first server searches for relevant information in response to a request from a valid user terminal and transmits the searched for information to the user terminal.
(1) a process of recording predetermined user identification information assigned in advance to a user;
(2) a process of receiving from the user terminal requesting for authentication at least the user identification information of the user using the user terminal, and when the received user identification information matches any user identification information that is already recorded, determining that the user terminal is valid and generating terminal identification information to be recorded in the user terminal;
(3) a process of recording and transmitting the generated terminal identification information to the user terminal; and
(4) a process of comparing the terminal identification information received when the user terminal accesses predetermined information with the terminal identification information that is already recorded so as to determine whether the received terminal identification information is valid; and
(5) a process of allowing, when the received terminal identification information is valid, the access from the user terminal.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing an overall structure of a network system to which the present invention is applied;

FIG. 2 is a diagram showing a detailed structure of an intranet;

FIG. 3 is a diagram showing a structure of a router;

FIG. 4A is a diagram for explaining the contents of a NAT table provided to a router outside the intranet, and showing a case where data directed from a public communication network to a firewall are routed;

FIG. 4B is a diagram showing a case where data directed from the firewall to the public communication network are routed;

FIG. 5 is a functional block diagram of a host server using a DOMINO server;

FIG. 6 is an explanatory diagram showing a mechanism of replication performed between the host server and a local server;

FIG. 7 is a functional block diagram showing the structure of an authentication server;

FIG. 8 is an explanatory diagram for explaining data recorded in an information recording part of the authentication server;

FIGS. 9A and 9B are diagrams showing examples of a hierarchical table used in a large-scale system having possibility that a number of services are provided to a single user terminal;

FIG. 10 is a diagram for explaining a procedure in the case where individual address books of about 10 persons are copied from an interoffice address book;

FIG. 11 is a diagram for explaining a procedure in the case where an individual address book is copied to a mail file;

FIG. 12 is a diagram for explaining a procedure in the case where an employee accesses the host server;

FIG. 13 is a diagram for explaining the procedure of a receiving process;

FIG. 14 is a diagram for explaining a procedure of an individual number assigning process;

FIG. 15 is a diagram for explaining the flow of a process performed in an authentication server at the time of authentication;

FIG. 16 is a diagram for explaining the procedure of a received message process;

FIG. 17 is a diagram for explaining the procedure of a delete process;

FIG. 18 is a diagram for explaining the procedure of a reply process;

FIG. 19 is a diagram for explaining the procedure of a forward process;

FIG. 20 is a diagram for explaining the procedure of a FAX process;

FIG. 21 is a diagram for explaining the procedure of a transmission process;

FIG. 22 is a diagram for explaining the procedure of a search process;

FIG. 23 is a diagram for explaining the procedure of a search list display process;

FIG. 24 is a diagram for explaining the procedure of a new keyword process;

FIG. 25 is a diagram for explaining the procedure of a scheduling process;

FIG. 26 is a diagram for explaining the procedure of a creation process of a schedule list;

FIG. 27A is a diagram showing an example of a screen displayed on a display part of the mobile phone, and shows a login screen;

FIG. 27B shows a main screen;

FIG. 27C shows a screen at the time of the receiving process;

FIG. 27D shows a screen at the time of the receiving process;

FIG. 27E shows a document display screen;

FIG. 27F shows a screen at the time of the transmission process;

FIG. 28A shows a main screen showing the case where search is selected;

FIG. 28B shows a screen at the time of the search process;

FIG. 28C shows an input screen for a new key word;

FIG. 28D shows a list screen representing a search result by the new key word;

FIG. 28E shows a document display screen after search;

FIG. 29A shows a main screen showing the case where scheduling is selected;

FIG. 29B shows a screen in a list display area of a schedule list;

FIG. 29C shows a screen for selecting schedule creation menu; and

FIG. 29D shows a data input screen for creating a new schedule list.

### DETAILED DESCRIPTION OF THE PREFERRED EMBODIMENTS

A preferred embodiment of the present invention is described with reference to the drawings.

General Structure

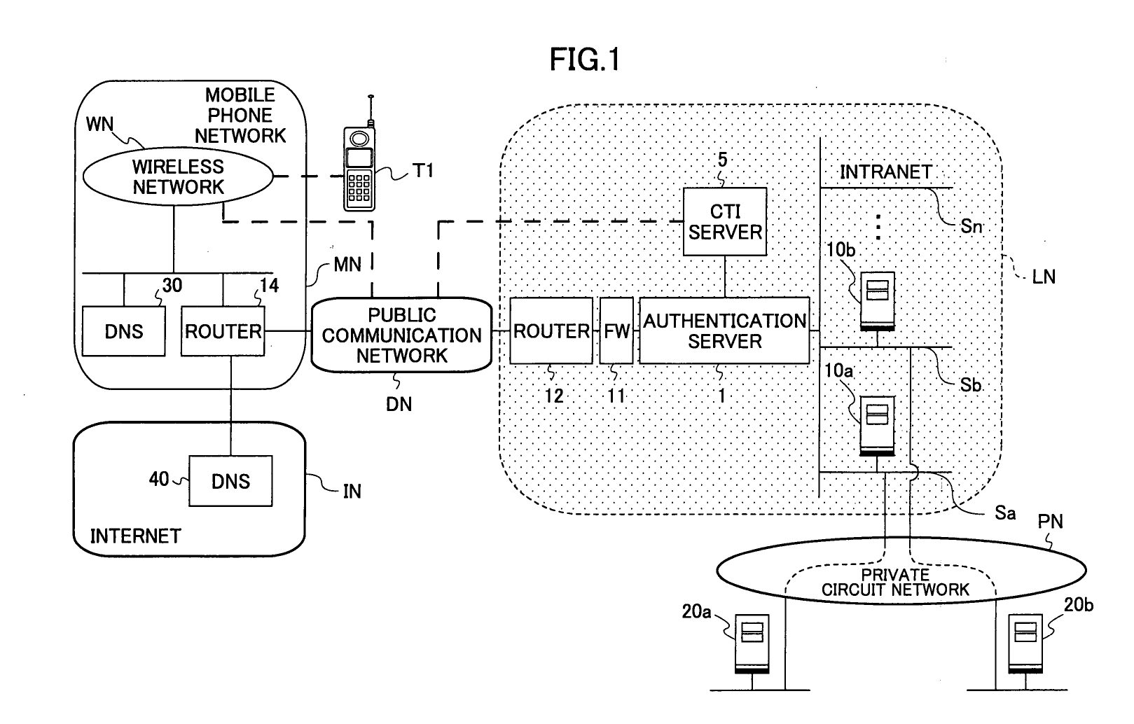

FIG. 1 is a diagram showing a general structure of a network system to which the present invention is applied. A network system according to this embodiment is a network system that can be built after the fact and includes a secure intranet LN, which is installed in a management company in which a public communication network DN is laid down.

The intranet LN includes a plurality of segments Sa-Sn, each of which is connectable to a private circuit network PN.

The segments Sa-Sn are assigned to equip host servers 10a, 10b, . . . , each of which are first servers of a user company to be managed.

An authentication server 1, a fire wall (FW) 11 and a router 12 are provided in the vicinity of the entrance of the intranet LN. Only a specific access from an authorized user terminal T1 can pass these and is directed to any one of the segments Sa-Sn within the intranet LN. That is, security is maintained with respect to accesses from outside the intranet LN.

The access from the user terminal T1 is directed to the fire wall 11 via a mobile phone network MN including a wireless network WN, the public communication line DN connected to a router 14 within the mobile phone network, and a router 12 connected to the public communication network DN.

The mobile phone network MN is managed by an entity that provides communication services for mobile phones.

It should be noted that, as used herein, the term mobile phone includes PHS as well as mobile phone (mobile phone wireless device) in the narrow sense.

The user terminal T1 is a combination of a terminal, such as a notebook computer and a PDA, and a mobile phone described above. In the case of an intelligent mobile phone (mobile phone having an information processing mechanism), the mobile phone may serve as a user terminal by itself.

A browser program for forming a browser screen is installed in the user terminal T1. The browser program may be originally installed in the user terminal T1. Alternatively, the browser program may be loaded from the host servers 10 as a “Java Applet (Java: registered trademark)” on a case-by-case basis.

The user terminal T1 incorporates a predetermined recording medium for recording terminal identification information, which is described below. The recording medium allows at least writing of information and is formed by RAM, for example. In the case where the user terminal T1 is a Java-compliant i-mode mobile phone terminal, the recording medium is formed by a ScratchPad.

A program for reading and transmitting the terminal identification information is also installed in the user terminal T1. For example, a program may be written in a language other than Java. Further, the user terminal T1 is provided with an environment wherein, in the case of a mobile phone, the terminal identification information can be read from ROM thereof by using KVM, which is one of the execution environments for Java.

The user terminal T1 is further provided with an input part formed by, for example, numeric pads, and allows inputting of IDs (authentication ID and user ID described below) and passwords (authentication password and user password described below).

As is well known, the mobile phone network MN is provided with a DNS (Domain Name Server) 30, and the Internet IN is provided with a global DNS 40. The DNS 30 and the DNS 40 include address tables in which corresponding relationships between domain names and IP (Internet Protocol) addresses are described. By referring to both address tables, it is possible to solve the problem of difference in addresses at the time of accessing.

The private circuit network PN is a communication network formed by an assembly of private circuits and virtual private circuits (public circuits (virtual private network) virtually dedicated for parties concerned with the use of, for example, encryption technologies and encapsulation techniques).

As for the private circuit network PN, since so-called next generation communication networks (for example, a private circuit network called “PRISM” (PRISM is a registered trademark of JAPAN TELECOM CO., LTD)) have been in practical use, and plural access points are prepared all over Japan or all over the world, it is possible to reduce operational costs by using them.

In this embodiment, local servers 20a and 20b, which are examples of second servers of a user company located in distant places, are connected to the private circuit network PN via the respective nearest access points. The local servers 20a and 20b are connected to the corresponding host servers 10a and 10b via the private circuit network PN such that two-way communications can be performed.

Structure of Intranet

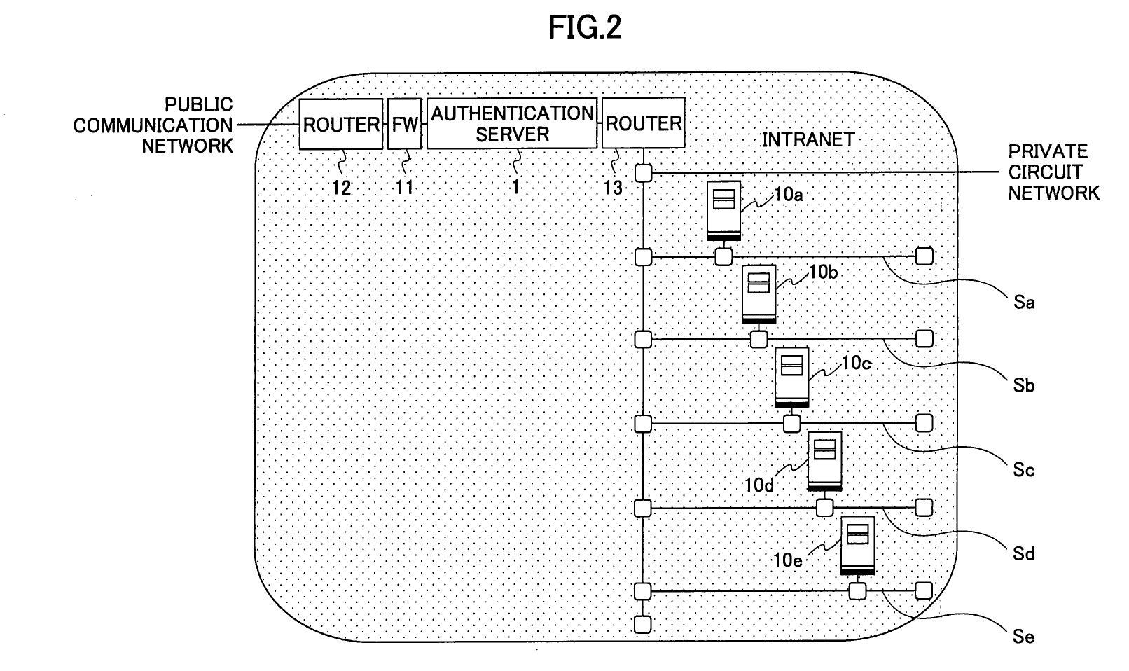

FIG. 2 shows a detailed structure of the intranet LN.

FIG. 2 shows an example of the intranet LN formed by five segments Sa through Se. Each segment, for example, the segment Sa, includes plural connection ports: one of them is connected to the host server 10a, and another one is connected to a router 13. By connecting a specific circuit of the private circuit network PN to a port of the router 13, a user company can individually use the segment Sa.

A switching hub (intelligent communication path switching device) or a router may be provided between the segment Sa and the private circuit network PN, and connection to the private circuit network PN may be made via it. The same applies to the other segments Sb through Se.

In a state where the host servers 10a through 10e are provided for connection ports of the segments Sa through Se, respectively, and a local server is connected to each of the host servers 10a 20, through 10e via a switching hub 14 and the private circuit network PN, a secure housing is provided in the intranet LN.

That is, since all of the host servers 10a through 10e are connected to the corresponding local servers via the private circuit network PN, there is no place for intervention by a third party. Since the segments Sa through Se provided with the host servers 10a through 10e, respectively, are each protected by a firewall 11, a housing is provided where it is difficult for an unauthorized person to gain access or intrude.

Accordingly, by allocating each of the segments Sa through Se of such a housing to a user company, it is possible for the user company to build its own secure private network environment (or groupware environment) at low cost.

Configuration of Router

The routers 12, 13 and 14 perform routing (path control) in the third layer (network layer) of the OSI (Open Systems Interconnection) Basic Reference Model. Since they are connected in the network layer, it is possible to perform data relay even if the second layer (data link layer) and the following layer of the OSI Basic Reference Model are different. Since the routers 12, 13 and 14 also include path setting functions, different networks may be connected, for example, the intranet LN and the public communication network DN, and the intranet LN and the private circuit network PN.

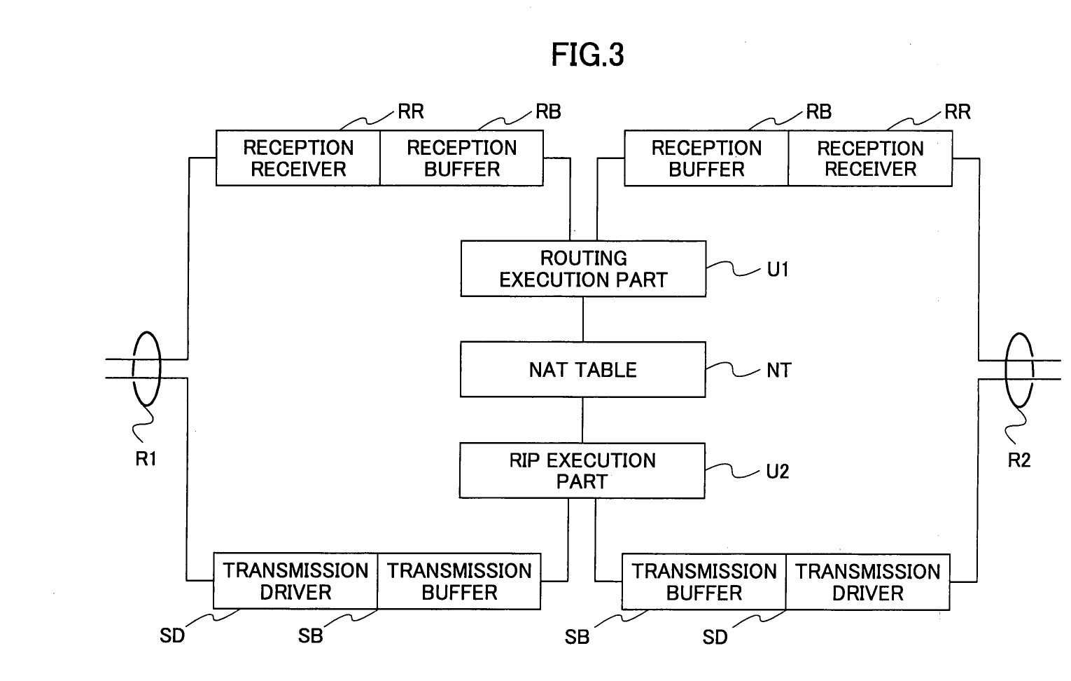

FIG. 3 is a diagram showing a configuration of the router. Since the router performs two-way routing, a reception receiver RR and a reception buffer RB, and a transmission driver SD and a transmission buffer SB are provided symmetrically with respect to transmission channels R1 and R2. Further, the router includes a routing execution part U1, a NAT (Network Address Translation) table NT, and a RIP (Routing Information Protocol) execution part U2.

The reception receiver RR receives data from the transmission channels R1 and R2. The reception buffer RB stores received data. The transmission driver SD transmits (forwards) data to the transmission channels R1 and R2. The transmission buffer SB stores data to be transmitted (forwarded). The routing execution part U1 performs address conversion by processing a received RIP, and establishes a communication path. The RIP execution part U2 transmits a necessary RIP to the transmission channels R1 and R2. Addresses used in address conversion, that is, “Destination” representing a destination address and “Source” representing a sender's address, are recorded in the NAT table NT.

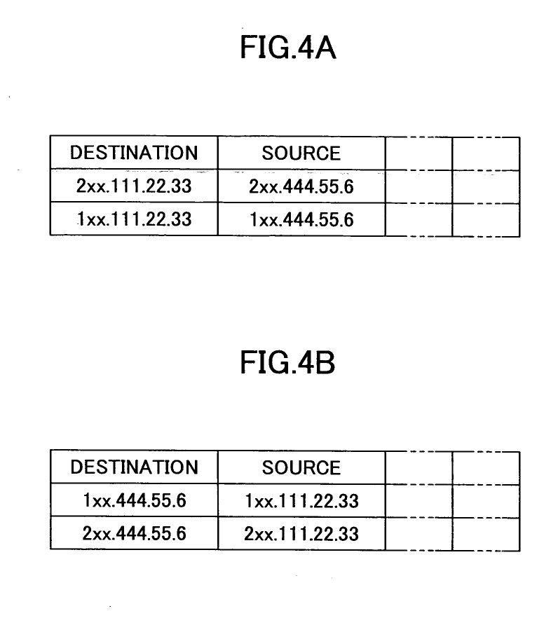

FIG. 4 is a diagram showing contents of the NAT table, which is included in the outer router 12 of the intranet LN. FIG. 4A shows the NAT table in the case of routing data directed from the public communication network DN to the firewall 11. FIG. 4B shows the NAT table in the case of routing data directed from the firewall 11 to the public communication network DN.

“2XX.111.22. 33” is the IP address of the local server 20 of the user company whose domain is registered. “1XX.111.22.33” is the IP address of the host server 10. “2XX.444.55.6” is the IP address in the Internet of a source terminal. “1XX.444.55.6” is the IP address of a source terminal that can be recognized in the intranet LN. By setting the NAT table as shown in FIG. 4, it is possible to access the intranet LN with an IP address different from that in the Internet.

The address of a source terminal of an access that passes through the firewall 11, and the address of the host server to be managed are set in the NAT table of the router 13. By setting the NAT table in the aforementioned manner, it is possible to realize communication path control means for selectively establishing a communication path between a source terminal whose access has passed through the firewall 11 and a segment (a host server provided thereto).

In the case where a router is used instead of the switching hub 14, addresses are set to the NAT table in a similar manner.

Host Server and Local Server

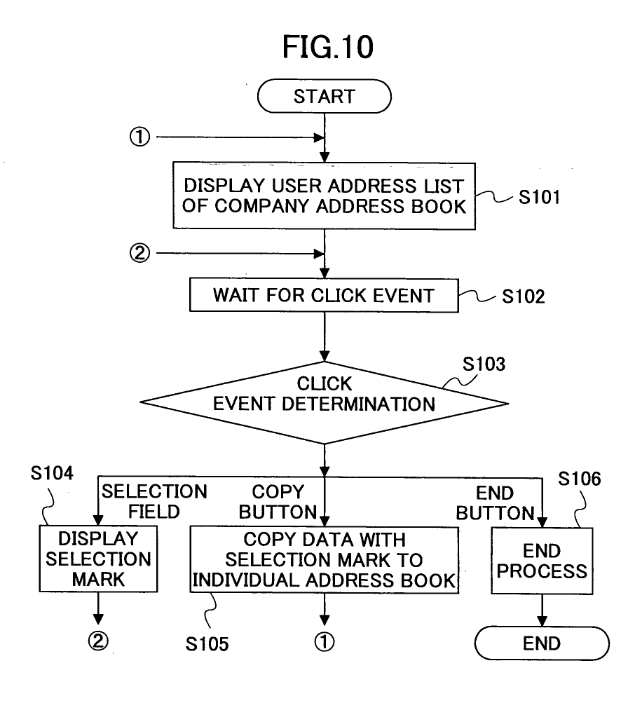

A description is given of the host servers (10a and 10b in FIGS. 1 and 10a through 10e in FIG. 2: hereinafter denoted by the reference numeral 10 from which a suffix is omitted, when it is unnecessary to identify each of them) and the local servers (20a, 20b and the followings in FIG. 1: denoted by the reference numeral 20 from which a suffix is omitted, when it is unnecessary to identify each of them).

In principle, one local server 20 corresponds to one host server 10, and each of them is connected via the private circuit network PN. However, a plurality of local servers 20 may correspond to one host server 10, and each local server 20 may be connected to a unique LAN (Local Area Network) to which one or more client terminals are connected. The point is, the host server 10 that exists in the intranet LN should correspond to the local server 20 that exists outside the intranet LN in a one-on-one manner.

The host server 10 is a computer that includes a Web Mail server function capable of forwarding data, a search function, a replication function and a scheduler function, and further includes a data base containing information which users intend to access, such as mail files and schedule files.

The search function is a function for searching for a relevant file in the database. The replication function is a function for activating and executing a replication task that performs replication of modified data in the database between the host server 10 and the local server 20. The schedule function is a function for managing schedule files prepared for each registered user company.

The local server 20 is a computer that includes at least the above-mentioned replication function and a database.

In this embodiment, at least a part of files in the database provided to each of the host server 10 and the local server 20 are, though not necessarily, common files that are maintained to have the same contents as those of the other server.

In the case where the host server 10 and the local server 20 form groupware, they are common files having common contents within the groupware.

For example, the contents of mail files and schedule files in the local server 20 are the contents of mail files and schedule files in the host server 10 as is.

Accordingly, accessing the common files of the host server 10 is substantially equivalent to accessing the common files managed by the local server 20.

Various embodiments may be contemplated for maintaining the common files of the host server 10 and those of the local server 20 to be common. In this embodiment, however, it is realized by mutually executing a replication task in each server.

That is, when the common files are modified in the local server 20, the local server 20 transmits to the host server 10 the difference data between the common files before and after the modification. In addition, when the local server 20 receives difference data from the host server 10, the local server 20 copies the difference data to own common files. The replication task in the case where the common files of the host server 10 are modified is also performed in a similar manner.

Configuration of Authentication Server

Next, a description is given of the authentication server 1. The authentication server 1 corresponds to an authentication apparatus of the present invention. When there is an access request from the user terminal T1 to information recorded in the common files of the host server 10, the authentication server 1 authenticates whether the user terminal T1 is authorized. When the user terminal T1, which issues the access request, is authorized, the authentication server 1 allows the access by the user terminal T1.

The authentication server 1 is realized by a server and a computer program recorded in a computer-readable recording medium.

A computer program is generally recorded in a recording apparatus provided to a server and is executed by properly reading from the recording apparatus by the CPU of the server. However, a computer program may be recorded in a portable recording medium such as a CD-ROM and a DVD-ROM. Alternatively, a computer program may be downloaded via a predetermined computer network.

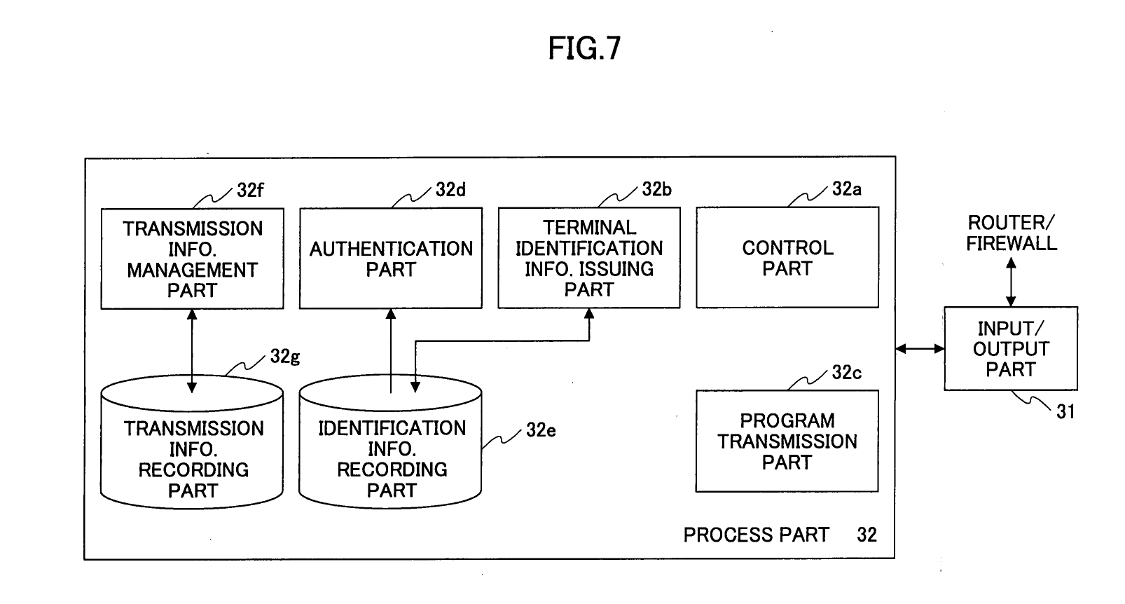

FIG. 7 is a block diagram of functions formed by executing the above-mentioned computer program by the CPU of the server. In this embodiment, an input/output part 31 and a process part 32 are formed.

The input/output part 31 performs communications while controlling inputs and outputs of data between the input/output part 31 and the user terminal T1, or between the input/output part 31 and the host server 10. More specifically, for example, the input/output part 31 receives user identification information and terminal identification information (both of which are described below) from the user terminal T1, returns a result of authentication to the user terminal T1 and controls subsequent inputs and outputs of data, or notifies the host server 10 of the result of authentication. When the input/output part 31 directs the result of authentication to the host server 10, the input/output part 31 also directs subsequent accesses of the user terminal T1 to the host server 10.

The process part 32 performs authentication and processes related to authentication, and can supply and receive data with respect to the input/output part 31. As shown in FIG. 7, the process part 32 in this embodiment includes functions of a control part 32a, a terminal identification information issuing part 32b, a program transmission part 32c, an authentication part 32d, an identification information recording part 32e, a transmission information management part 32f, and a transmission information recording part 32g.

The control part 32a controls basic operations of the apparatus. Each of the terminal identification information issuing part 32b, the program transmission part 32c, the authentication part 32d, the information recording part 32e, the transmission information management part 32f, and the transmission information recording part 32g performs operations under management by the control part 32a.

The control part 32a also includes a part of the functions of allowing means of the present invention. When the authentication part 32b, which is described below, authenticates that the user terminal T1 requesting for authentication is authorized, the control part 32a allows the user terminal T1 to access record information of the common files of the server 10.

The control part 32a also includes a function for generation data for displaying, on a display of the user terminal, transmission information with respect to each user terminal T1 based on below-mentioned data recorded in the transmission information recording part 32e. In this respect, the control part 32a also includes a function as transmission information presenting means of the present invention.

The terminal identification information issuing part 32b includes functions of a terminal identification information issuing part and a terminal identification information generation part of the present invention.

The terminal identification information issuing part 32b receives from the user terminal T1, requesting for access, user identification information allocated to a user who uses the user terminal T1. The terminal identification information issuing part 32b includes a function of comparing received user identification information with the allocated user identification information recorded in the identification information recording part 32g as described below, thereby determining whether the received user identification information is identical to any of the user identification information recorded in the identification information recording part 32g. When the received user identification information is identical to any of the user identification information recorded in the identification information recording part 32g, the terminal identification information issuing part 32b determines that the access requester based on the user identification information is authorized, generates terminal identification information to be recorded in the user terminal, and transmits the same to the user terminal.

The terminal identification information is transmitted to and recorded in the identification information recording part 32g in addition to being transmitted to the user terminal T1.

The user identification information is unique information with which each user can be distinguished from other users. In this embodiment, the user identification information consists of a user ID and a password, though this is not a limitation. The user identification information is allocated to each user in advance and recorded in the identification information recording part 32g. The user identification information may be, for example, properly allocated to each user by a network administrator, or properly selected by each user under management by the network administrator intended to avoid duplication.

On the other hand, the terminal identification information is unique information with which each user terminal T1 can be distinguished from other user terminals T1.

When there is an access request from the user terminal T1, the program transmission part 32c transmits a program written in, for example, Java to the user terminal T1. Such transmission is performed via the above-mentioned input/output part 31. Transmission of a program may be performed every time there is a request from the user terminal T1. Alternatively, transmission of a program may be performed only when there is a first access request from the user terminal T1, or only when the user terminal T1 does not include the program.

The above-described program is a program for causing the user terminal T1 to be authenticated to transmit the terminal identification information.

When an access request from the user terminal T1 reaches the authentication server 1, the authentication part 32d determines whether the user terminal T1 is authorized.

Specifically, the authentication part 32d performs the determination by checking consistency between the terminal identification information that is input from the user terminal T1 requesting for authentication and received via the input/output part 31 and the terminal identification information recorded in the information recording part 32e.

As mentioned above, the authentication part 32d determines validity of an access requester based on the consistency between the sets of terminal identification information. However, validity of an access requester may be determined based on validity of the terminal identification information and user identification information.

The terminal identification information, which is required for authentication, is recorded in the information recording part 32e. Additionally, in this embodiment, the user identification information is also recorded in the information recording part 32e. The terminal identification information and the user identification information are recorded for all of the user terminals T1 to be authenticated.

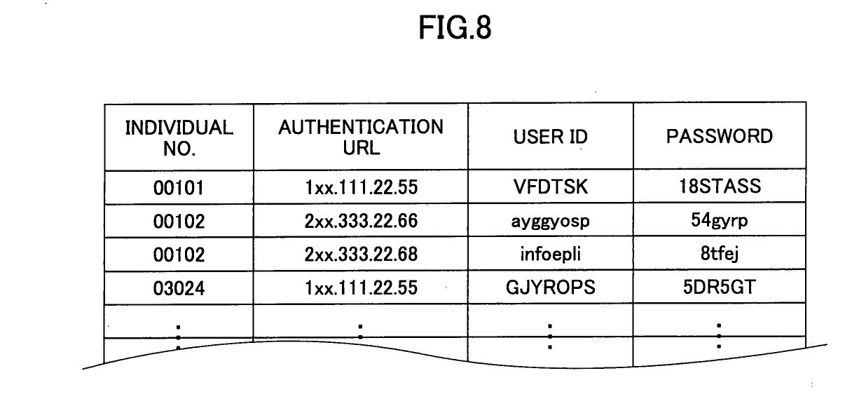

FIG. 8 shows examples of authentication information. Here, a set of a user ID (User ID) and a password (PASSWORD), and an authentication URL (for example, the URL of a desired host server 10), which is an example of information of an area in which each user terminal T1 is allowed to perform communications, are recorded with an individual number, which is an example of the terminal identification information, as an authentication table in a one-to-one corresponding relationship in principle.

However, there is a case where two or more user IDs are allocated with respect to one individual number. In this case, a different authentication URL is allocated to each of the user IDs. In the example of FIG. 8, two user IDs are allocated to an individual number 00102, and a different URL is allocated to each of them.

The user IDs and passwords in this example consist of only numbers, only letters, or a combination thereof. In the example of the authentication table shown in FIG. 8, the individual number corresponds to the authentication URL in a one-to-one manner in principle. Accordingly, this may be a preferred authentication embodiment for a simple system in which only corresponding relationships between one user terminal T1 (individual number) and approximately one or two host servers 10 (authentication URL) may be considered.

Even in the case where the individual number, the user ID and the password are used for authentication, a set of the user ID, the password and the individual number corresponds to the authentication URL in a one-to-one manner in principle. Thus, a user may login with the user ID/password that the user currently knows in accordance with the authentication URL to be accessed. In the aforementioned manner, a process for logging-in is simplified. As mentioned above, this may be a preferred authentication embodiment for a simple system.

In the case where a user accesses a plurality of host servers 10 with a single user terminal T1 to enjoy services, or where one host server 10 includes a plurality of service programs, and authentication is required for each of them, it is necessary to create a log-in screen or maintain a user ID and a password for each of the host servers or each of the service programs. Hence, maintenance and management of the system becomes complicated. In addition, there is a case where it is necessary to invalidate a user ID and a password because the user has lost the user terminal T1 or has the user terminal T1 stolen. In such a case, the invalidation must be performed on all host servers recorded in the authentication table or on all service programs, which is complicated.

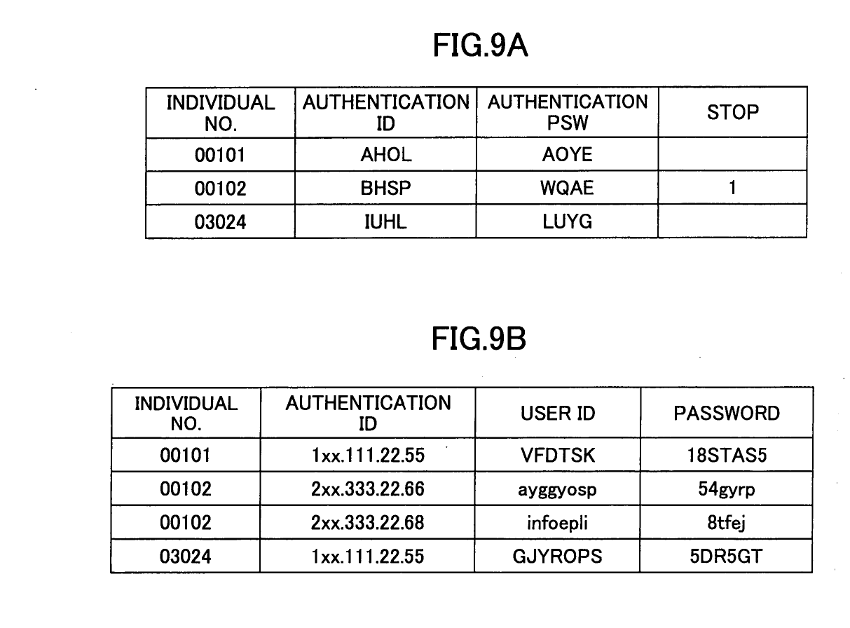

Accordingly, in the case of a large-scale system in which one user terminal T1 may enjoy multiple services, an embodiment is preferred in which authentication data are managed in a hierarchical manner by using, for example, an authentication master table shown in FIG. 9A and an authentication table (the same as that of FIG. 8) shown in FIG. 9B.

The authentication master table is a higher table to be linked to the authentication table by the individual number. In the authentication master table, one field is prepared for one individual number. In each field, recording areas for an authentication ID, an authentication password (authentication PSW), and a suspension flag for a relevant user terminal are formed.

The authentication ID (the same as the user ID) is ID information that serves as a master ID. Only one master ID is allocated to the user terminal T1. Even in the case where a plurality of user IDs are recorded in the authentication table of FIG. 9B (FIG. 8), the authentication ID is used for validating authentication by using it. The same applies to the authentication password. The recording area of the suspension flag is an area that allows random updating. When the flag is “1”, the area is used for completely suspending the use of the authentication table with respect to the user terminal T1.

When canceling the suspension, the authentication table can be used by deleting the flag “1”.

As mentioned above, with the use of two tables in a hierarchical manner, an operation for accessing is simplified since, even if there are a plurality of host servers 10 or service programs that can be accessed, the user should know only the authentication ID and the authentication password. Additionally, maintenance and management operations of a system are also simplified since, even if the user terminal T1 is lost, merely setting “1” into the recording area of the suspension flag will suffice.

The authentication part 32d compares the terminal identification information received from the user terminal T1 (in this embodiment, it is assumed that an individual number automatically transmitted from the authentication server serves as the terminal identification information, though this is not a limitation) with the individual number recorded in the information recording part 32e. In addition, the authentication part 32d compares the user ID or authentication ID received from the user terminal T1 with the user ID or authentication ID recorded in the information recording part 32e. Further, the authentication part 32d compares the password received from the user terminal T1 with the password or authentication password recorded in the information recording part 32e.

In the case where the set of the received terminal identification information, user ID (authentication ID) and password (authentication password) match the terminal identification information, user ID (authentication ID) and password (authentication password) with respect to a certain user terminal T1, it is authenticated that the user terminal T1 requesting for access is authorized.

Information indicating that it is authorized is transmitted to the control part 32a together with information of the authentication URL associated therewith in the authentication table.

The control part 32a, which receives it, directs the access from the user terminal T1 to a relevant authentication URL. Thereby, communications between the accessing user terminal T1 and the target host server 10 become possible.

The transmission information management part 32f manages data to be recorded in the transmission information recording part 32g.

The transmission information management part 32f extracts information transmitted from the host server 10 to the user terminal T1, generates transmission information indicating what information is transmitted, and records the transmission information in the transmission information recording part 32g by associating the transmission information with each user terminal T1. In this respect, the transmission information recording part 32g includes a function as an extracting part. In addition, the transmission information management part 32f also includes a function of reading data recorded in the transmission information recording part 32g. The read data are transmitted to the control part 32a and used for generating data for displaying the transmission information on the display of the user terminal T1 in a visible state. The data are transmitted to the user terminal T1 via the input/output part 31.

The network system structured as mentioned above may be operated as follows, for example.

As mentioned above, since each of the segments Sa through Se of the intranet LN is allocated to the host server of the user company to be managed, it is possible for the user terminal to use them in units of segments.

Only the segments Sa through Se (in this case, a user company provides the host server 10 and the local server 20 corresponding to the host server 10), or the segments Sa through Se provided with the host servers 10 having predetermined functions may be provided in an embodiment to be applied to a user company. The latter is suitable for the case where the user company already possesses the local server 20 corresponding to the host server 10.

When the user company to be managed, and the segments and the host server 10 to be provided in the intranet LN are determined, a system administrator registers in the firewall 11 various conditions (protocols, a data format unique to the system, the address of the host server 10, etc.). Further, the system administrator registers in an address table of the router 13 in the intranet LN the address of the host server 10 as a destination and a source in the intranet LN. In addition, the address of the host server 10 is registered to a connection source of the switching hub 14. Further, data of the terminal identification information (in this case, the individual number), the user identification information (in this case, the user ID (or authentication ID) and password (or authentication password)), and the authentication URL are recorded in the information recording part 32e of the authentication server 1 for each user terminal T1.

A member (normally, employee) of a user company operates the user terminal T1 to perform information access to a desired host server 10 with an IP address (for example, XXX@XXX.co.jp).

An access request is forwarded from the wireless network WN to the DNS 30 connected to the mobile phone network MN. The DNS 30 obtains a global IP address (for example, 2XX.111.22.33) for the user company from a global DNS 40 based on a domain name included in the access, and forwards it to the router 12.

Referring to the NAT table having the contents of FIG. 4A, the router 12 converts the global IP address supplied from the DNS to the IP address (1XX.111.22.33) of the host server 10, and simultaneously converts the global IP address (2XX.444.55.6) of the user terminal T1 to the IP address (1XX.444.55.6). By using a routing function, the access request is forwarded to the firewall 11. The firewall 11 determines whether the access complies with a condition registered in advance. When the access complies with the condition, the firewall 11 lets it pass through and forwards it to the authentication server 1.

The authentication server 1 determines whether the user terminal T1 requesting for access is authorized. When it is authenticated that the user terminal 1 is authorized, the access request is transmitted to the router 13. The process of the authentication is described later.

The router 13 interprets the contents of the access request to determine corresponding segment and host server 10, and forwards the access request to the host server 10.

The host server 10 searches the common files for data corresponding to the access request, and returns the data to the router 12 via the router 13, the authentication server 1 and the firewall 11.

Referring to the NAT table having the contents of FIG. 4B, the router 12 converts the address of the host server 10 to the IP address of the user terminal T1, and forwards reply data to the user terminal T1 via the public communication network DN and the wireless network WN with the use of the routing function.

The replication task is executed between the host server 10 and the local server 20 via the private circuit network PN, and the identity of the contents of the common files of both of them is maintained. Hence, information returned from the host server 10 is the same as the information held by the local server 20. Accordingly, by using such a network system, it is possible to easily realize a system exclusive for the company which system is inexpensive and assures security.

Particularly, since information (mail files and schedule files, etc.) held by the local server 20 can be securely obtained by the user terminal T1 whose location is not specified, it seems as if the user terminal T1 and the local server 20 are connected to each other via a private circuit, thus there is no intervention by a third party. Hence, it is very convenient for handling in-house information.

In addition, according to the network system, for example, by making all information handled by a local server in the head office of a company and local servers of a plurality of branch offices into common files, centrally managing the common files by the host server in the intranet NL, and allowing the user terminal T1 to access the common files at an arbitrary time point from an arbitrary place, it is possible to access compatible in-house information with a unified operation. Thus, a preferred operation of groupware in a company is easily realized.

Application 1: Interoffice Mailing System

Next, a description is given of an application of the network system.

Here, an example is given of the case where the network system is applied to an inter-office mailing system wherein a specific segment of the intranet LN is allocated to a certain user company, and inter-office information of the user company is accessed with the use of the user terminal T1.

“Mail” refers to, as used herein, the system including not only normal e-mail documents but also various list data and edited data, and various documents that are previously registered. Further, “mail” refers to Web mails allowing attachment of documents thereto and having no limitation to the number of usable characters and/or the number of mails to be stored.

By using Web mails, it is possible to send and receive e-mails with a unified operation that is not dependent on the type of the user terminal T1.

As for the user terminal T1, since mobile phones having a Web mail function and capable of serving as user terminals, such as “i-mode (TM) terminals” provided by NTT DoCoMo, Inc., are widely used, it is possible to use them.

However, not an i-mode server for “i-mode terminals” but a Web mail server function provided by the host server 10 is used as a mail server. Thereby, it becomes possible to lift limitations on various usages imposed by the i-mode server, such as the kinds, sizes and amount of data that can be transmitted/received, while using an operational environment of a standard browser function provided to an “i-mode terminal”. In addition, it becomes possible to realize a unified operational environment that absorbs differences among models.

Computers installing “DOMINO server. (DOMINO (or Domino) is a registered trademark of Lotus Development Corporation, U.S.A.; the same applies throughout the specification)”, which is provided by Lotus Development Corporation, may be used as the host server 10 and the local server 20.

“DOMINO server” includes preferred functions for implementing the present invention as standard functions, such as a communication function, a mail function, a server function (particularly HTTP server function), a scheduling function, and a replication function. In addition, since programming for improving the existing functions is allowed, it is convenient to use it.

Web mail functions suitable for implementing the present invention, such as editing a menu list exclusively for interoffice mail, adding fee information to each document, automatically dividing and sending a large volume of data in accordance with the memory capacity of a receiving end, generating a reduced display of an attached document and displaying it in a limited display area of a mobile phone, and displaying only text by limiting the display of mail addresses in the case where there are many mail addresses, can be readily realized by creating an application program in addition to standard mail functions provided to “DOMINO server”.

Further, by additionally creating an application program, it is possible to readily realize, as the scheduling function, a function for constantly monitoring the current time and extracting only schedules after the current time.

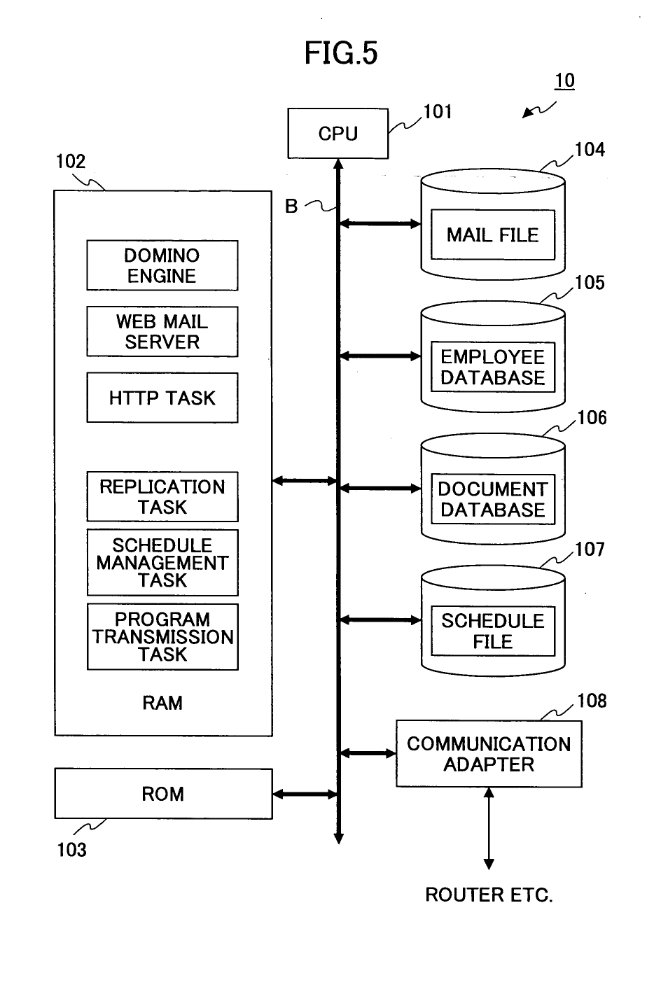

FIG. 5 is a functional block diagram of the host server 10 using the “DOMINO server”.

The host server 10 includes a CPU 101 operating under management by a predetermined OS (operating system), a RAM 102, a ROM 103, a mail file 104 built in a fixed storage such as a hard disk that can be read by the CPU 101, an employee database 105 recording a mail address book and personal information of employees, a document database 106 recording, for example, HTTP documents, a schedule file 107 recording interoffice schedule data, and a communication adapter 108 that controls communications with, for example, the router 13.

The RAM 102 stores a program for realizing the Web mail server function for employees, in addition to a DOMINO engine, a replication task, an HTTP task and a schedule management task, which are standard programs of the DOMINO server. The ROM 13 records a control program including BIOS (Basic Input Output System) and the like.

The DOMINO engine provides a unified operational environment while absorbing differences among platforms and network OSs, and can realize robust functions including integration and searching for documents.

The HTTP task is a task that, upon reception of a HTTP transmission request from a mobile phone, specifies a data file corresponding to the HTTP transmission task and converts it to an HTML format. Since an extended URL may be used, it is possible to dynamically convert the data file corresponding to the HTTP transmission request to the HTML format.

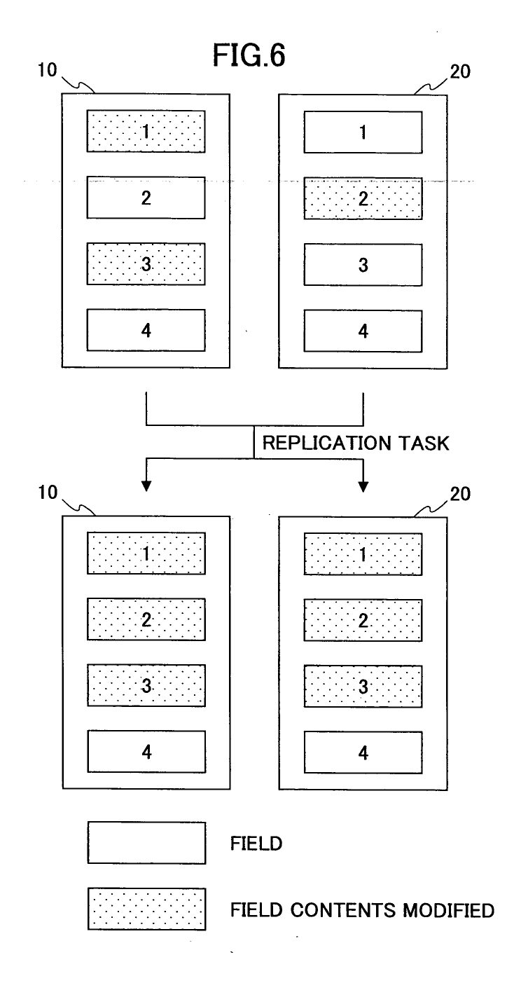

The host server 10 and the local server 20 maintain coincidence between respective common files by the replication task shown in FIG. 6. That is, based on the configurations of respective directories, the replication task is activated at regular time intervals, and one's common files are compared with the other's so as to determine whether there is any difference therebetween. If there is any difference, the difference data are transferred to each other, thereby reflecting the difference to the contents of own common files.

Replication is performed in units of fields as shown in the figure. This is different from normal “file copy” in that only those modified fields are copied.

Next, referring to FIGS. 10 through 29, a description is given of use embodiments of an interoffice mailing system.

(Advance Preparation)

By operating in advance a client terminal (illustration thereof is omitted) of the local server 20, a pair of a user ID and a password is set as allowance information. It should be noted that an employee ID is used as the user ID. The set contents are reflected in the employee database 105 of the host server 10. Here, authentication for accessing the intranet LN from a mobile phone and information required for charging are set. Identification data of each group are allocated to the employee ID or the password in this exemplary embodiment in order to enable charging for each group (department). Charging in the case where a mobile phone is used is performed in accordance with the total amount of data (total amount of packet size). Hence, it is made compilable for each identification data set. Addresses of mobile phones are also set in advance in the employee database 105.

Further, terminal identification information, the user ID, the password, and information of authentication URL are set in the authentication server 1.

(Creation of Address Book for Mobile Phone)

The addresses of about ten people are extracted from the interoffice address book in the employee database employee database 105, and are prepared for transmission to mobile phones as needed. In principle, this is performed in the above-mentioned client terminal.

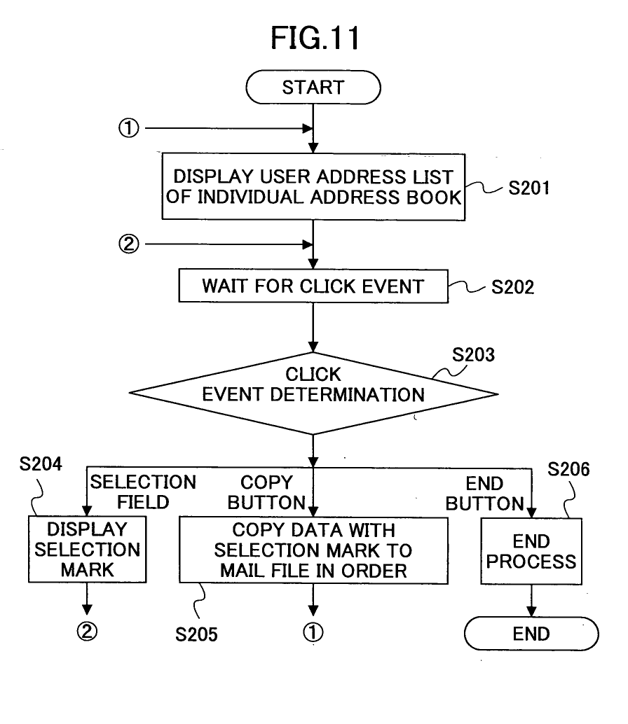

FIGS. 10 and 11 show the procedure in this case.

Referring to FIG. 10, first, a user address list of the interoffice address book is displayed on a display device of a mobile phone, which is the user terminal (S101). A click event (among displayed events, one selected by a click operation by a user; the same applies throughout the specification) is waited for (S102), and if a click event occurs, the contents thereof are determined (S103).

If the click event occurs in a “selection field”, a selection mark is displayed before a specific person and the process returns to S103 (S104). In the case of a “copy button”, the data of the person marked with the selection mark are copied to an individual address book, and the process returns to S101 (S105). In the case of an “end button”, an end process is performed (S106). In the aforementioned manner, the individual address book formed by the addresses of several persons is generated.

When extracting an address to be actually used from the individual address book, a process is performed in the procedure shown in FIG. 11.

First, the user address list of the individual address book is caused to be displayed on the display of the client terminal (S201). A click event is waited for (S202), and if a click event occurs, the contents thereof are determined (S203).

If the click event occurs in the “selection field”, a selection mark is displayed before a specific person and the process returns to S203 (S204). In the case of the “copy button”, the data marked with selection marks are sequentially copied to a mail file, and the process returns to S201 (S205). In the case of the “end button”, the end process is performed (S206).

It should be noted that the process of extracting addresses from the interoffice address book so as to create the address book for a mobile phone may be performed by the mobile phone. In this case, however, direct extraction from the interoffice address book is performed instead of replication to the individual address book.

(Authentication and Information Access)

Next, a description is given of an operational procedure in the case of accessing the host server 10 from a mobile phone by a member of the user company.

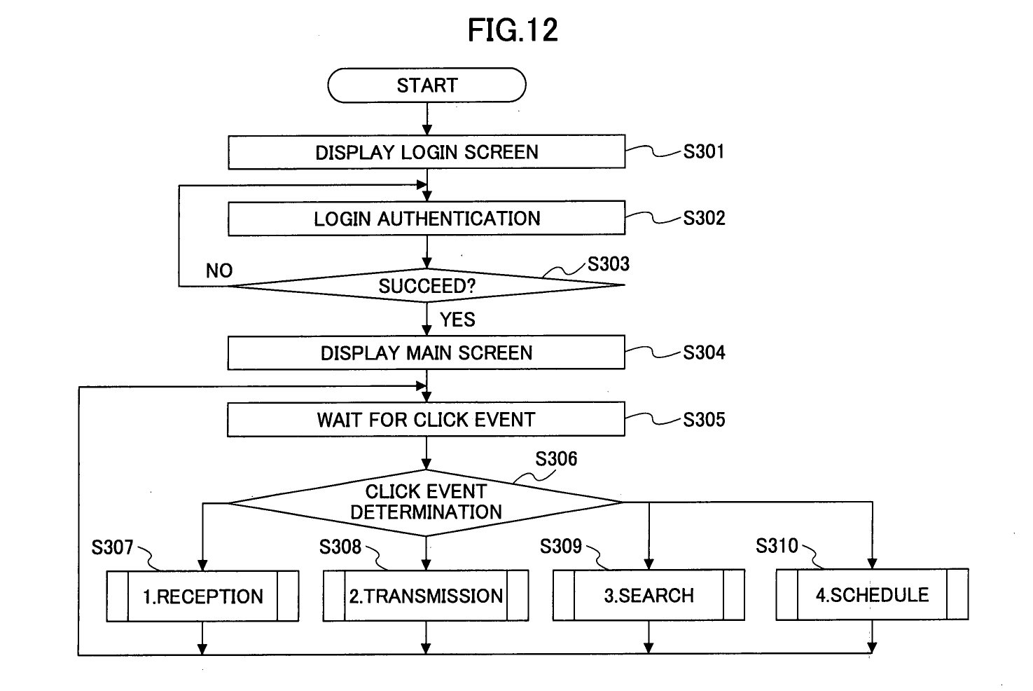

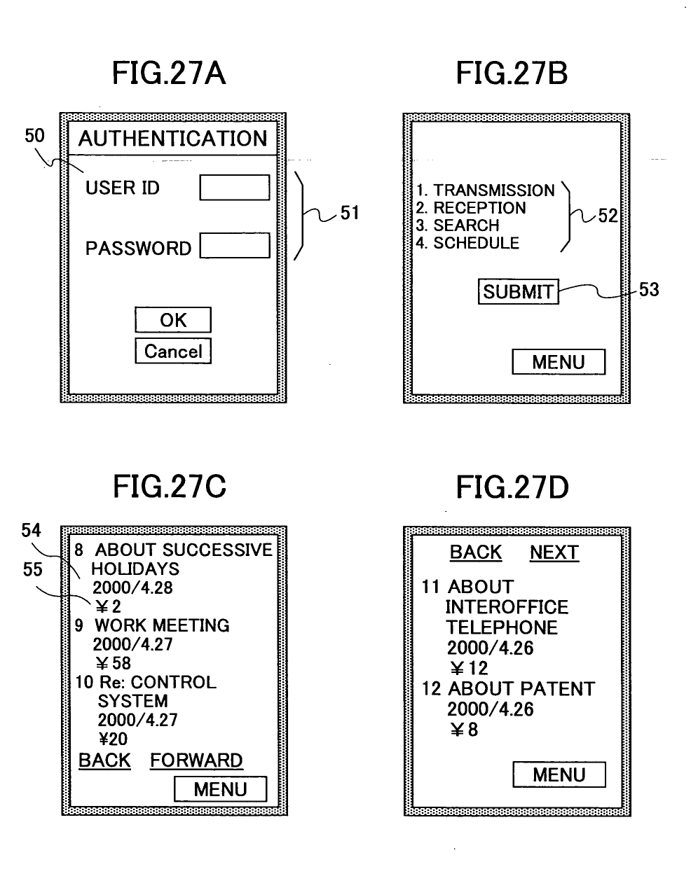

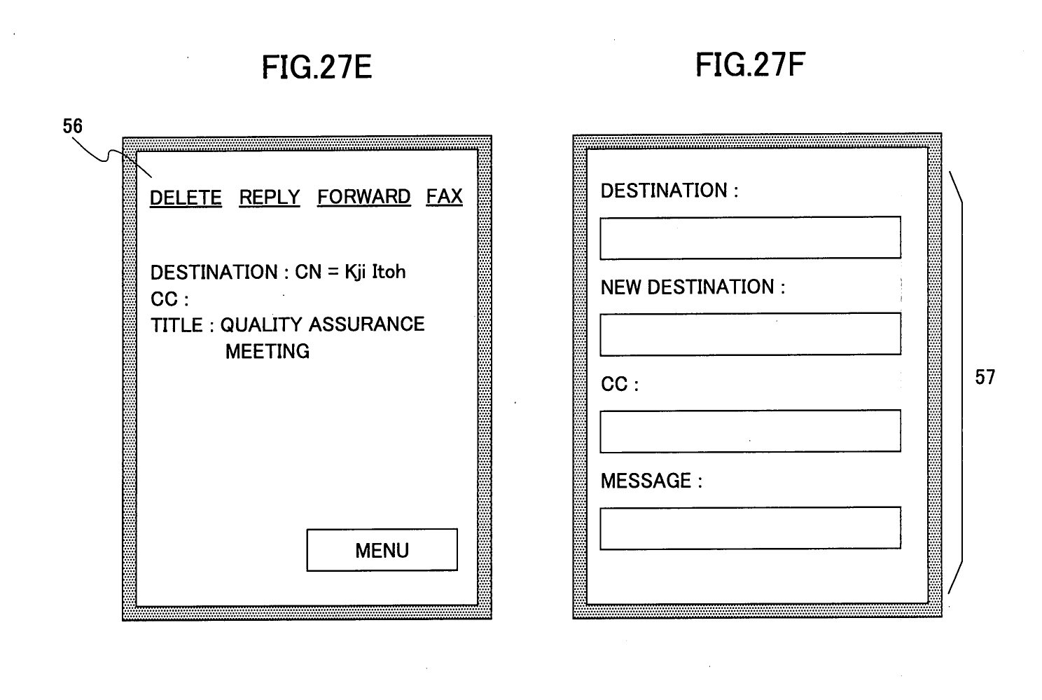

FIG. 12 is a diagram for explaining an overall procedure of an information accessing method. First, an access request is issued by the mobile phone. Concurrently with the access request, a URL regarding a requested connection destination is transmitted to the authentication server. Subsequently, a login screen is displayed on a display part of the mobile phone (S301). As shown in FIG. 27A, input fields 51 for the user ID (here, the employee ID; the same applies throughout the specification) and the password are displayed in the login screen. When a user ID and a password are input, login authentication is performed (S302). It is determined whether the login authentication succeeds (S303). If the authentication fails (S303: NO), the process returns to S302. When the authentication succeeds (S303: YES), that is, in the case of an authorized user, a main screen is displayed (S303: Yes, S304). The main screen is such as shown in FIG. 27B, for example, and an event selection region 52 for reception/transmission/search/schedule and a SUBMIT selection region 53 are displayed therein.

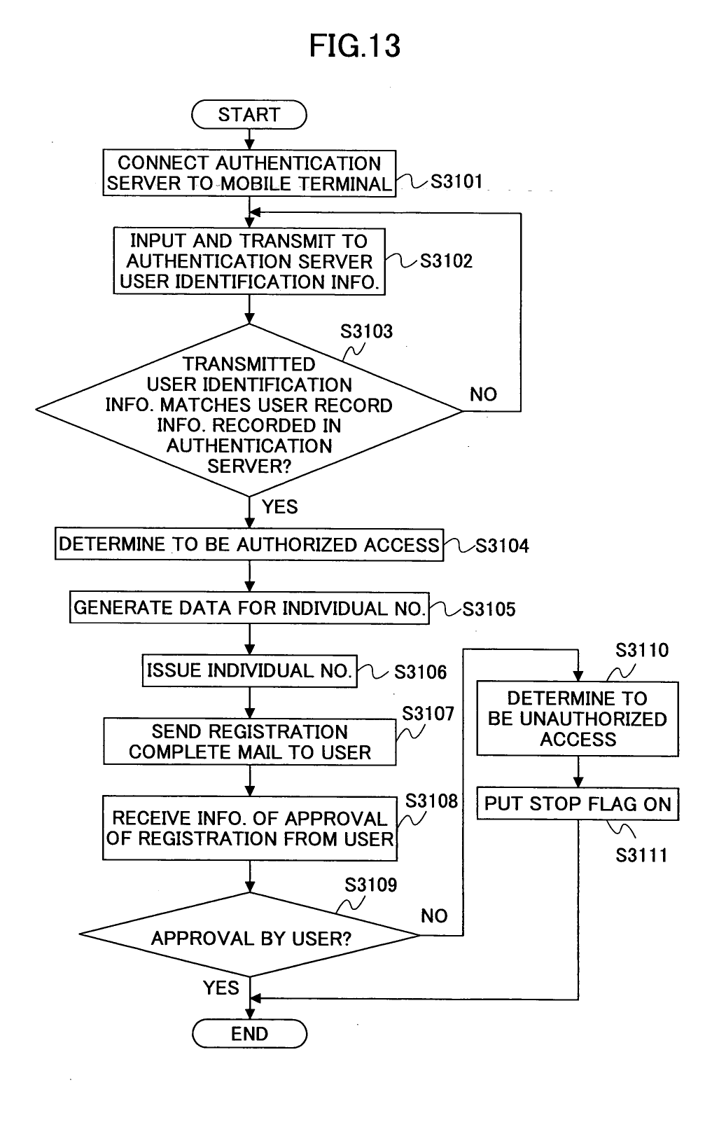

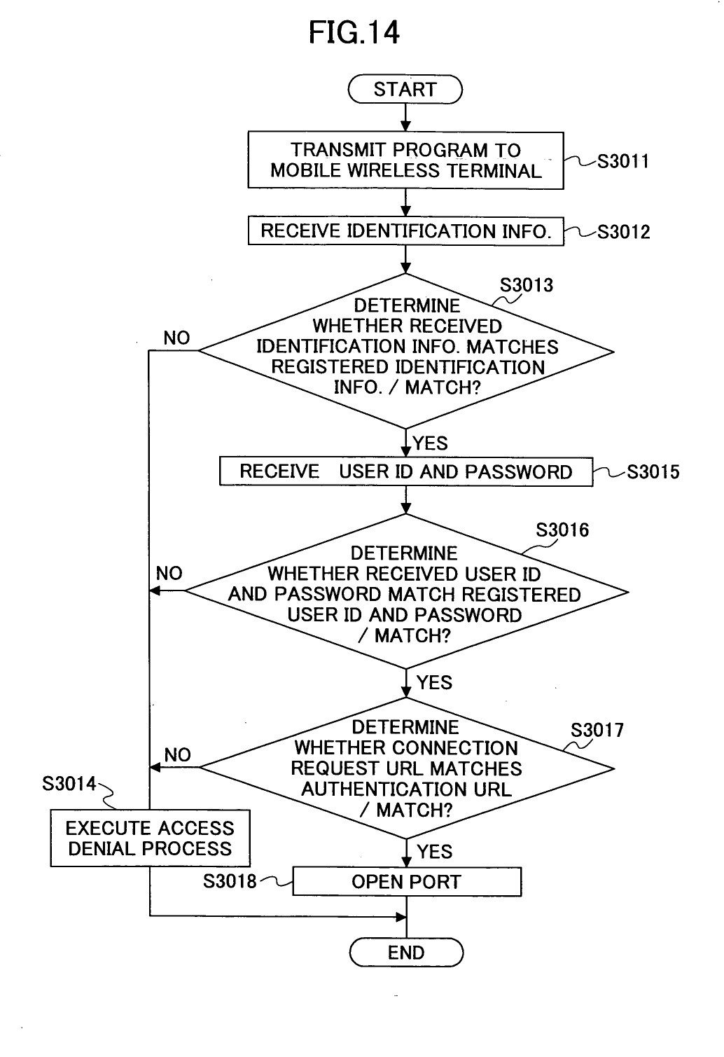

Using FIGS. 13 and 14, a detailed description is given of the login authentication described above.

FIG. 13 is a diagram showing the procedure of a numbering process of the individual number, which process is performed prior to the login authentication. As mentioned above, the individual number unique to each user terminal T1 is used in the authentication in this embodiment. The individual number is assigned to each user terminal T1 by the authentication server S1.

The individual number is assigned to each user terminal in the following manner.

First, the user terminal T1 is connected to the authentication server S1 (S3101). Specifically, by inputting the URL designating the authentication server 1 as the requested connection destination, the user terminal T1 is connected to the authentication server 1. When such a connection is established, a screen similar to the one shown in FIG. 27A is displayed on the screen of the user terminal T1. The user inputs the user ID and the password, which are previously allocated to the user, in the input fields 51 in accordance with instructions on the screen. The data regarding the input user ID and password are transmitted from the user terminal T1 to the authentication server S1. The data are transmitted to the terminal identification information issuing part 32b in the process part 32 via the input/output part 31 (S3102).

The terminal identification information issuing part 32b (see FIG. 7) determines whether the user ID and the password indicated by the received data match any pair of a user ID and a password recorded in advance in the identification information recording part 32e (S3103). When the user ID and the password indicated by the received data match a pair of a user ID and a password recorded in advance in the identification information recording part 32e (S3103: Yes), the terminal identification information issuing part 32b determines that the access is authorized (S3104). When the access is determined to be authorized (S3104), the terminal identification information issuing part 32b generates data with respect to the individual number unique to each user terminal T1 (S3105), thereby issuing the individual number (S3106). The issuing process of the individual number is, specifically, performed by transmitting data with respect to the generated individual number to the identification information recording part 32e and the user terminal T1.

The data with respect to the individual number transmitted to the identification information recording part 32e are, as shown in FIG. 8, recorded in association with the authentication URL, the User ID (user ID) and the PASSWORD (password) of the terminal T1. On the other hand, the data transmitted to the user terminal T1 are recorded in a recording medium incorporated therein. In the case where the user terminal T1 is, for example, a Java-compliant i-mode mobile phone terminal, the data indicating the individual number are recorded in a scratch pad as mentioned above. The individual number is recorded in the mobile phone terminal in such a form that cannot be recognized by the user. Thus, in principle, the user will not recognize the individual number allocated to his/her user terminal T1.

In the case where the user ID and the password indicated by the received data do not match any pair of a user ID and a password recorded in advance in the identification information recording part 32e (S3103: No), the access is determined to be unauthorized. In this case, the process returns to the data input and transmission process of the user ID and the password (S3102), and this process is performed again. The process is repeated until the correct user ID and password are input. In the case where correct user ID and password are not input after all, the process ends here. However, in the case where the number of times of inputting a user ID and a password is limited, and it has not been determined that the access is authorized even though input of a user ID and a password has been performed for the limited number of times, then reception of further user ID and password may be stopped and the process may be shut down. As for assigning an individual number, the above-mentioned process suffices. In this embodiment, however, the following process is further performed.

In addition to the user identification information consisting of a user ID and a password, an e-mail address used by the user, which address is associated with each of the components of the user identification information and is identified by each of the components of the user identification information, is recorded in the identification information recording part 32g in this case. The e-mail address is, not necessarily but in this embodiment, usable in the user terminal T1 (user terminal T1 that the user intends to use in the system) to which the individual information is transmitted.

Here, when the above-mentioned issuance of the individual number is performed, the control part 32a reads from the identification information recording part 32g the e-mail address associated with the user identification information used in issuing the individual number, and transmits to the e-mail address a mail for notifying the user that registration of the individual number ends (S3107).

The mail is transmitted to the predetermined e-mail address recorded in advance in the identification information recording part 32g, irrespective of whether the person who operates the user terminal T1 is an authorized user.

It is practically possible for a third party who knows the user identification information in some way to perform the above-mentioned process regarding registration of the individual number. However, it is unlikely that the third party knows as well as the above-mentioned e-mail address, which is registered in advance by the authorized user. In addition, even if the third party knows the e-mail address, normally, further user ID and password, for example, are required in order to transmit/receive an e-mail using the e-mail address. Accordingly, even if a third party, having found the user identification information of a certain user, poses as an authorized user with the use of a user terminal T1 other than the user terminal T1 for the relevant user, and thereby obtains an individual number, it is impossible for the third party to receive the above-mentioned mail that notifies of completion of registration. On the other hand, the user who has registered in advance the user identification information and the e-mail address can receive from the authentication server 1 the above-mentioned mail that notifies completion of registration of the individual number, irrespective of whether the above-mentioned process for assigning an individual number is performed by the user himself/herself or the third party posing as the relevant user.

When the authorized user has performed the above-mentioned process for assigning an individual number, the user who receives the above-mentioned e-mail notifying of completion of individual number registration can understand the meaning of the reception of the e-mail. The user who receives it transmits to the authentication server 1 information that the registration is acknowledged by, for example, e-mail. On the other hand, when the third party posing as an authorized user has performed the above-mentioned process, the user who receives the above-mentioned e-mail notifying of completion of individual number registration does not understand the meaning of reception of the e-mail. The user who receives this transmits to the authentication server 1 information that the registration is not acknowledged by e-mail or the like. In either case, the authentication server 1 receives information by the user as to whether the registration is acknowledged.

In the aforementioned manner, it is possible for the authentication server 1 to check whether the above-mentioned procedure for assigning an individual number is performed by an authorized user.

When the authentication server 1 receives the above-mentioned information, the information is transmitted to the control part 32a. The control part 32a determines whether the contents indicated by the information represent that the procedure for assigning an individual number is acknowledged by the user (S3109). When the user acknowledges the procedure for assigning an individual number (S3109: Yes), the procedure for assigning an individual number ends assuming that the above-mentioned procedure has been performed by the authorized user. On the other hand, when the user does not acknowledge the procedure for assigning an individual number (S3109: No), it is determined that the above-mentioned procedure for assigning an individual number has not been performed by the authorized user (S3110). In this case, the control part 32a puts a stop flag ON that stops a process for assigning an individual number with the use of the user ID and password used for issuing the relevant individual number and a process for login authentication described below (S3111), and ends the process for assigning an individual number.

The flag is maintained as is until the cause of putting the flag ON is ascertained. For example, in response to an e-mail notifying of completion of individual number registration, the user may have by mistake transmitted information that the user does not acknowledge the registration, though the user should have transmitted to the authentication server 1 information that the user acknowledges the registration. In the aforementioned manner, a third party is prevented from illegally obtaining an individual number.

Further, there are variations as follows for the process subsequent to step (S3107).

First, in the above-mentioned embodiment, the user who receives the e-mail by the process of step (S3107) transmits information with respect to acknowledgement of the registration by e-mail (the authentication server 1 receives the information (S3108)). However, instead of this, the user may transmit such information by telephone.

In order to realize this, information regarding a telephone number used by the user may be recorded in the identification information recording part 32g, in addition to the information regarding the e-mail address used by the user. The telephone number may be made available to the user terminal T1 (user terminal T1 that the user intends to use in the system) to which the individual information is transmitted. In this variation, after the issuance of the individual number, the control part 32a transmits a mail to the e-mail address associated with the user identification information used in issuing the individual number. The mail includes: information for notifying the user that registration of the individual number ends; and information for asking to make a phone call to a predetermined telephone number so as to express whether to acknowledge completion of registration. Upon reception of the mail, the user makes a phone call to the designated telephone number and transmits information regarding acknowledgement of registration. The apparatus that receives the access from the user terminal T1 may transmit, to the user terminal T1 that is making the phone call, information for outputting from the user terminal T1 a voice message such as “An individual number has been assigned. Do you acknowledge this? If you acknowledge, please push the key 0, if you do not, please push the key 1.” Upon hearing the voice message, the user transmits information for expressing whether or not to acknowledge the registration process of individual number by operating the key 0 or 1. The information is directly or indirectly received by the authentication server 1. The control part 32a of the authentication server 1 that receives the information determines whether the above-mentioned procedure for assigning an individual number is acknowledged by the user (S3109). The subsequent procedure is similar to that is the above-mentioned case. The advantage of doing so lies in that the authentication server 1 can check the validity of a party that transmits the information regarding acknowledgement of the registration process of an individual number by comparing telephone numbers recorded in the identification information recording part 32g with the telephone number of the caller who transmits the information. Of course, even if e-mail is used, it is also possible to check validity of a party that transmits the information by comparing the e-mail address of the caller and e-mail addresses recorded in the identification information recording part 32b. However, it is technically far more difficult to falsify the telephone number of a caller than to falsify the e-mail address of a sender in e-mail. Accordingly, by implementing such a variation, it is possible to further reduce the possibility that posing occurs.

In addition, there is another variation as follows.

In the above-mentioned variation, based on the information regarding acknowledgement of the registration process received by e-mail or telephone, the control part 32a determines whether there is user acknowledgement. When the user acknowledges the procedure for assigning individual number (S3109: Yes), it is determined that the above-mentioned procedure for assigning the individual number is performed by an authorized user. When the user does not acknowledge the above-mentioned procedure for assigning the individual number (S3109: No), it is determined that the above-mentioned procedure for assigning the individual number has not been performed by an authorized user (S3110). When it is determined that an authorized user has performed the procedure for assigning the individual number, the procedure for assigning the individual number ends. When it is determined that an unauthorized user has performed the procedure for assigning the individual number, the stop flag is put ON (S3111). In this variation, the handling of the stop flag is opposite to that in the above-mentioned variation.

In this variation, the stop flag is put on in an initial state. When it is determined that an authorized user has performed the procedure for assigning the individual number, the procedure ends after putting down the stop flag so as to enable the use of the individual number, etc. On the other hand, when it is determined that an unauthorized user has performed the procedure for assigning the individual number, the procedure ends with the stop flag being put on as is. In the aforementioned manner, by limiting the use of an individual number, etc, in principle and allowing the use of the individual number, etc, only when a correct procedure is performed, it is possible to further reduce occurrence of posing.

A specific procedure for login authentication, which is performed in principle when the procedure for assigning the individual number as mentioned above has been performed, is as shown in FIG. 14.

As mentioned above, login authentication is commenced when a mobile phone requests for an access. Concurrently with the access request, a URL regarding a requested connection destination is transmitted to the authentication server from the mobile phone, and the login screen is displayed on the display part of the mobile phone (S301). Thus far, the description is as given above.

When the login screen is displayed, the authentication server 1 transmits to the mobile phone a program for reading and transmitting the individual number of the mobile phone to the authentication server. More specifically, information that there is the access request is transmitted to the control part 32a via the input/output part 31. Upon reception of the information, the control part 32a transmits to the program transmission part 32c an instruction to perform transmission of the program. Based on the instruction, the program transmission part 32c transmits the above-mentioned program to the mobile phone via the input/output part 31.

In this variation, the above-mentioned program is written in, for example, Java, and executed on a KVM of the mobile phone. In any event, the program runs in an execution environment prepared in the mobile phone. The program activates a program that reads the individual number of the mobile phone from, for example, a scratch pad. A functional realization body thus generated transmits to the authentication server 1 the individual information read from, for example, a ROM. This process is performed automatically. In addition, the process may be performed in such a manner that cannot be recognized by the user. Further, the program may self-destruct after fulfilling a function of reading the individual number of the user terminal T1 and transmitting to the authentication server 1 data regarding the individual number of the user terminal T1.

On the other hand, the program may remain after fulfilling the function of reading the individual number of the user terminal T1 and transmitting to the authentication server 1 data regarding the individual number of the user terminal T1. In this case, the program may be recorded in a predetermined recording medium of the user terminal T1, and read from the recording medium every time the functions of reading the individual number of the user terminal T1 and transmitting to the authentication server 1 data regarding the individual number of the user terminal T1 are performed. In the case where such a program is used, the above-mentioned program is transmitted only when there is an access request from the user terminal T1 and the access request is issued for the first time. However, when the program is required after, for example, the program disappears from the recording medium for some reason, the program may be transmitted again. In the case where the user terminal T1 is, for example, a Java-compliant i-mode mobile phone, the recording medium in which the program is recorded may be formed by a nonvolatile memory incorporated therein.

In the case where the user terminal T1 has not followed the above-mentioned procedure for assigning an individual number and does not have an individual number, even if the program is received and executed, or the program is read and executed from the recording medium, an individual number is not transmitted from the user terminal T1 to the authentication server 1. In the case where an individual number is not transmitted, the authentication server 1 requests the user for transmission of a user ID and a password, and performs the above-mentioned procedure for assigning an individual number. In this case, the procedure for assigning an individual number and authentication are performed in a subsequent manner.

Upon reception of the individual number (S3012), the authentication part 32d of the authentication server 1 determines whether the individual number matches any of individual numbers recorded in the information recording part 30e (S3013). When the received individual number does not match any of the recorded individual numbers (S3013: No), data for displaying information indicating the fact on the display of the mobile phone are generated and transmitted to the mobile phone (S3014).

In this case, the mobile phone is not authenticated as a qualified one. Thus, the access from the mobile phone is not allowed.

It should be noted that, in this embodiment, the control part 32a performs generation of the data for causing the display of the mobile phone to display an image.

When the received individual number matches any of the recorded individual numbers (S3013: Yes), the process proceeds to the next step.

Subsequently, the user ID and the password that are input by the user are received from the mobile phone (S3015), and the authentication part 32d determines whether the user ID and the password match, among user IDs and passwords recorded in the information recording part 30d, those associated with the individual number (S3016).

It should be noted that, since reception of the user ID and the password from the mobile phone is performed independently from reception of the individual number, the reception may be performed prior to step S3011.

When the received user ID and password do not match those associated with the individual number among the user IDs and the passwords recorded in the information recording part 30e (S3016: No), data for displaying information indicating the fact on the display of the mobile phone are generated and transmitted to the mobile phone as in the above-mentioned case (S3014).

When the received user ID and password match, among the user IDs and the passwords recorded in the information recording part 30e, those associated with the individual number (S3016: Yes), the process proceeds to the next step.

When the individual number and the received user ID and password match the user ID and the password recorded in the information recording part 32e in a mutually associated manner, those associated with the individual number, the mobile phone that issues the access request may be authenticated as a valid one. In this embodiment, however, in order to further increase reliability of authentication, the process as follows is performed.

That is, it is determined whether the previously received URL of the requested connection destination match, among authentication URLs recorded in the information recording part 30d, one that is associated with the received individual number, user ID and password (S3017). The determination is also performed by the authentication part 32d. When the received URL does not match, among the authentication URLs recorded in the information recording part 30d, one which is associated with the received individual number and user ID (S3017: No), the process proceeds to step S3014, as in the above-mentioned case. When there is a match (S3017: YES), the mobile phone is authenticated as a valid one, and the port is opened (S3018).

Additionally, in this embodiment, the description has been given of the cases where all or only the terminal identification information and the user identification information are used for authentication among: the terminal identification information, which is an individual number; the user identification information, which is a user ID and a password; and the authentication URL. However, authentication may be performed by using only the terminal identification information or only the terminal identification information and the authentication URL.

Referring again to FIG. 12, then, occurrence of a click event is waited for (S305). When a click event occurs, the contents thereof are determined (S306).

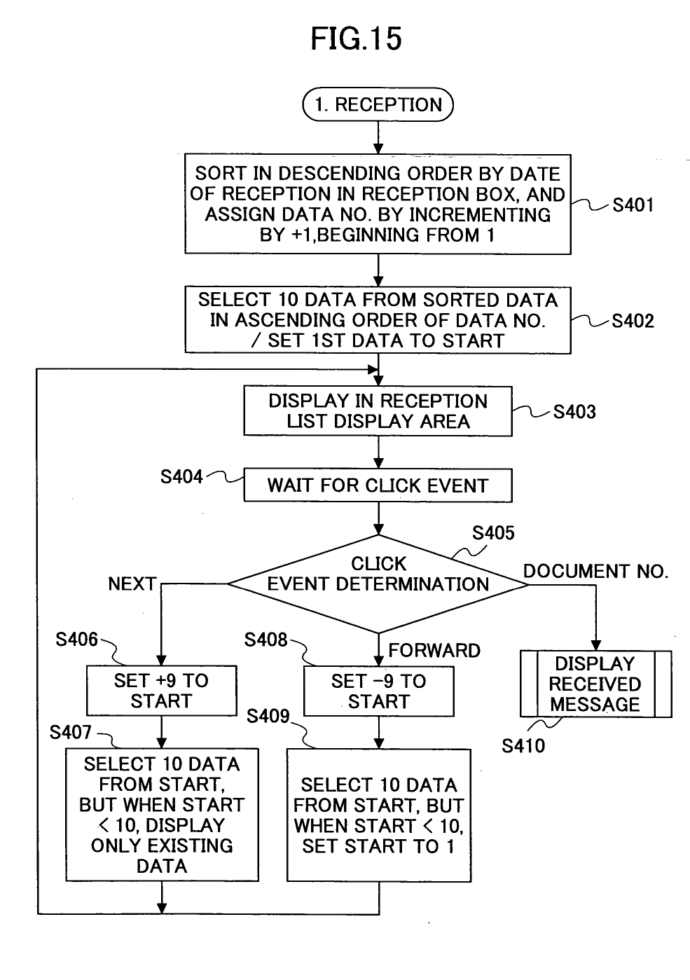

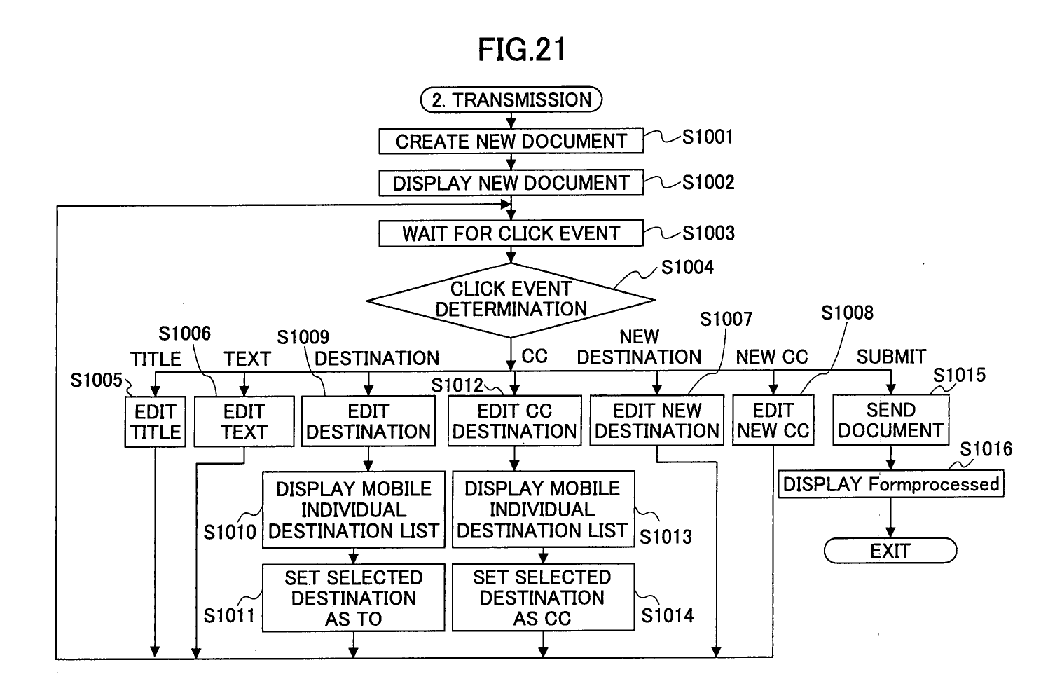

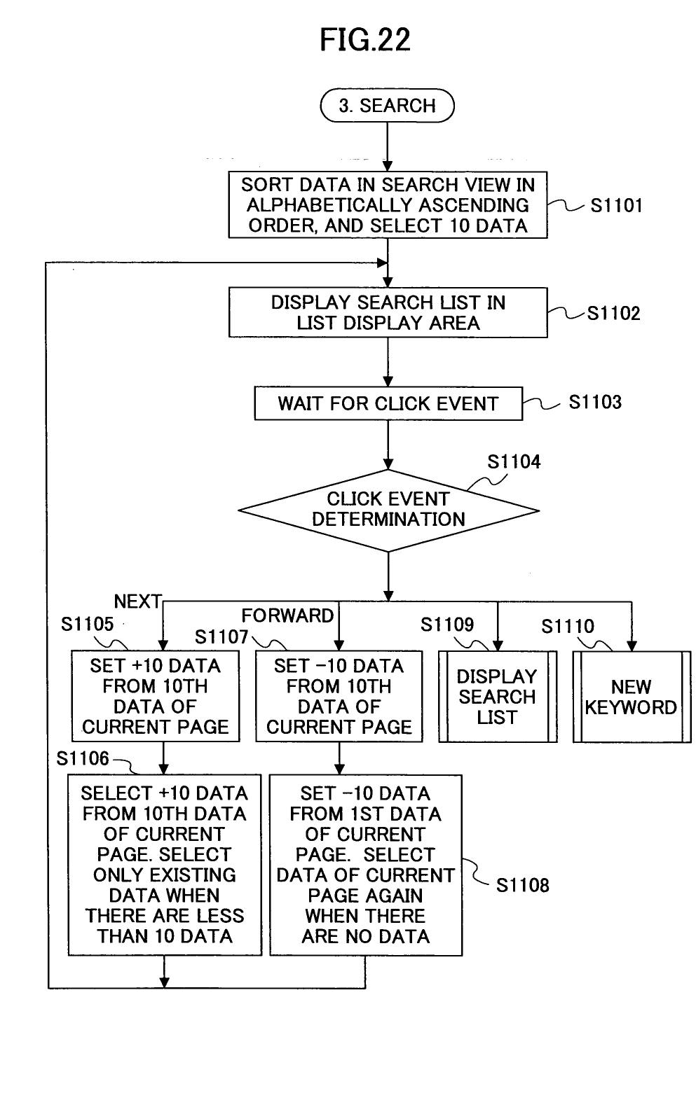

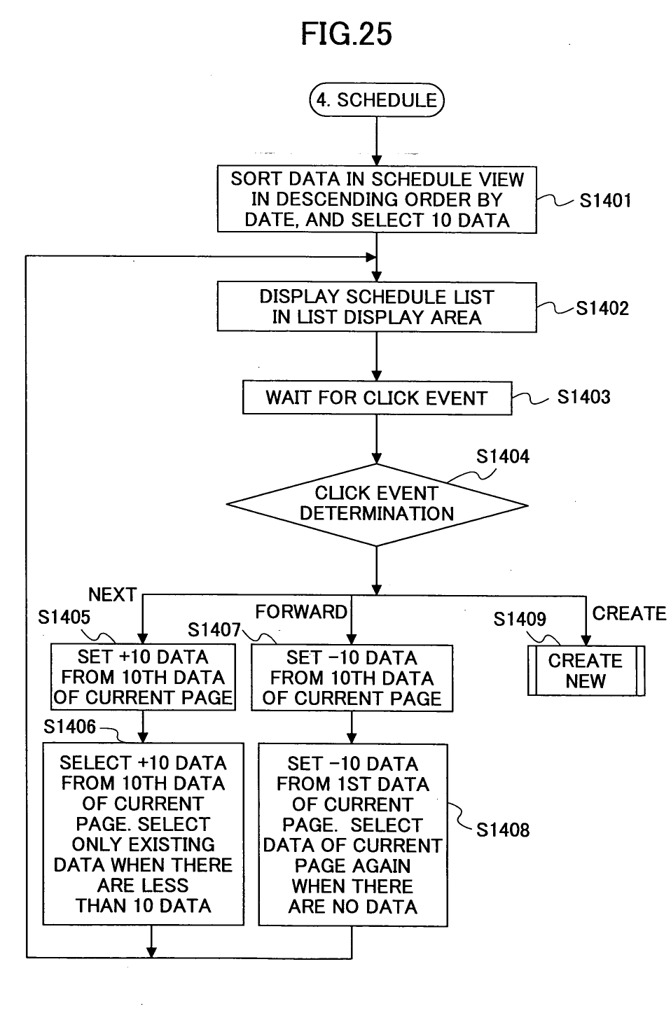

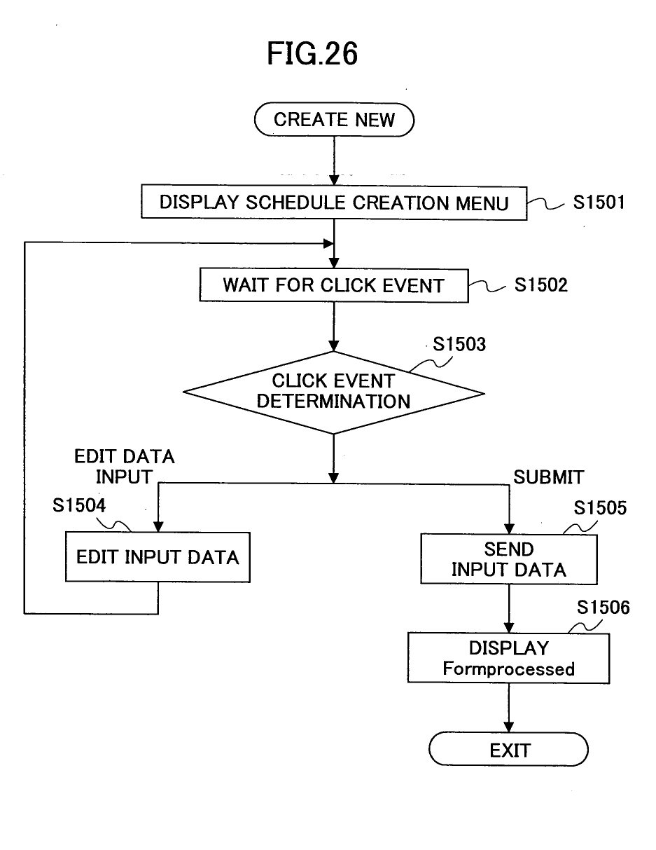

In the case where the click event is “reception”, a receiving process is performed in accordance with the procedure of FIGS. 15 through 20 (S307). In the case of “transmission”, a transmission process is performed in accordance with the procedure of FIG. 21 (S308). In the case of “search”, a search process is performed in the procedure of FIGS. 22 through 24 (S309). In the case of “schedule”, a scheduling process is performed in the procedure of FIGS. 25 and 26 (S310). When the process ends, the process returns to step S305.

A detailed description is given below of the receiving process, the transmission process, the search process and the scheduling process.

Receiving Process

A description is given of the receiving process of step S307.

In the reception process, as shown in FIG. 15, sorting is performed in descending order by the reception date in a reception box of the mobile phone, and a data number is assigned sequentially by “+1”, beginning from 1 (S401). The sorted data are selected by 10 sets in ascending order, and the first data are set to START (the first data number; the same applies throughout the specification) (S402). Then, the selected data are displayed in a reception list display area (S403). As shown in FIGS. 27C and 27D, title areas 54 and fee areas 55 representing information of fees required for reception thereof are shown in pairs in the reception list display area. In the aforementioned manner, by displaying the information of fee required for reception, it is possible to notify the user of the mobile phone the size of data and the cost thereof. It becomes possible for the user (i.e., employee) of the mobile phone to see the title and the fee so as to determine whether reading it is worth the cost and to estimate a time period required for reception based on the fee so as to determine whether to read it now or afterward. In addition, a large amount of data such as data having 2 million words are transmitted while being automatically subjected to mail splitting by the Web mail function. Hence, it becomes also possible to view it up to the middle, and stop viewing the subsequent split mails. Selection buttons of “back” and “next” are also displayed in the bottom portion of the reception list display area.

Occurrence of a click event is waited for (S404), and when a click event occurs, the contents thereof are determined (S405).

When the click event is “next”, “+9” is set to START (S406), and 10 sets of data beginning from the START are selected. When the START is less than 10, only existing data are displayed (S407).

When the click event is “back”, “−9” is set to START (S408), and 10 sets of data beginning from the START are selected. When the START is less than 10, “1” is set to the START (S409).

When the click event is “document number”, a received message display process is performed (S410).

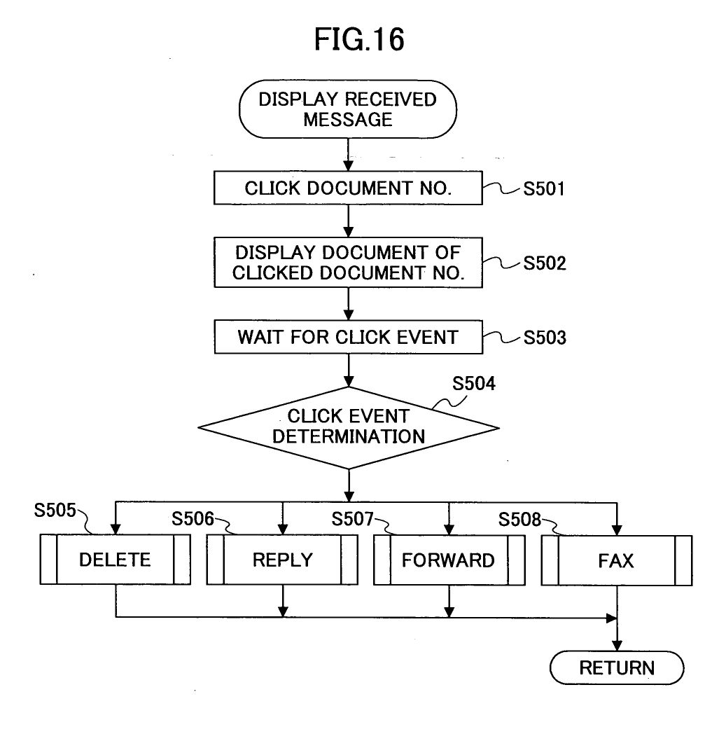

Details of the received message process of S410 are as shown in FIG. 16.

When it is detected that the user of the mobile phone has clicked a desired document number on the display part (S501), the document of the clicked document number is displayed on the display part (S502). The display then is, for example, as shown in FIG. 27E.

In the case where an attached document exists, a notice indicating the existence thereof is displayed on the display part. This is performed by the Web mail server function of the host server 10. When the attached document is a table object or bitmap data, by clicking the indication of the attached document, it is possible to display it as an HTML document with the size fit to the display area.

In addition, assuming the case of a document having a large number of destinations, displaying a destination portion in the frame of the received message is prevented in advance. In the aforementioned manner, it is possible to display only the message on the display part of the mobile phone. However, since information of destinations is managed by the host server 10, when it is desired to confirm the destinations from the mobile phone, it is possible to display them by requesting it via a browser screen (an icon or a command text is prepared).

In the case of the received message process, selection areas 56 of “delete”, “reply”, “forward” and “FAX” are displayed in the upper portion of the display part.

Occurrence of a click event is waited for (S503), and when a click event occurs, the contents thereof are determined (S504). Click events include a “delete” process (S505), a “reply” process (S506), a “forward” process (S507) and a “FAX” process (S508).

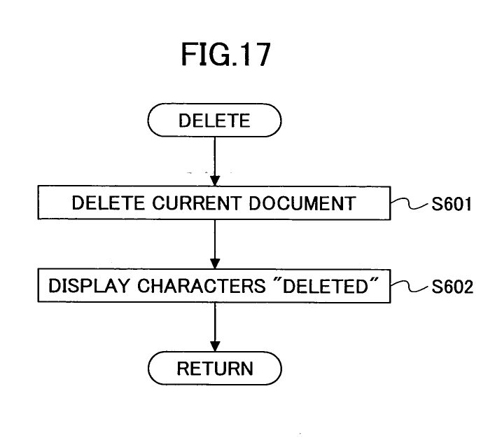

The “delete” process of step S505, that is, the procedure of a process in the case where “delete” is selected among the displayed contents of FIG. 27E, is as shown in FIG. 17. A current document is deleted (S601), and “Deleted”, which represents completion of deletion, is displayed (S602).

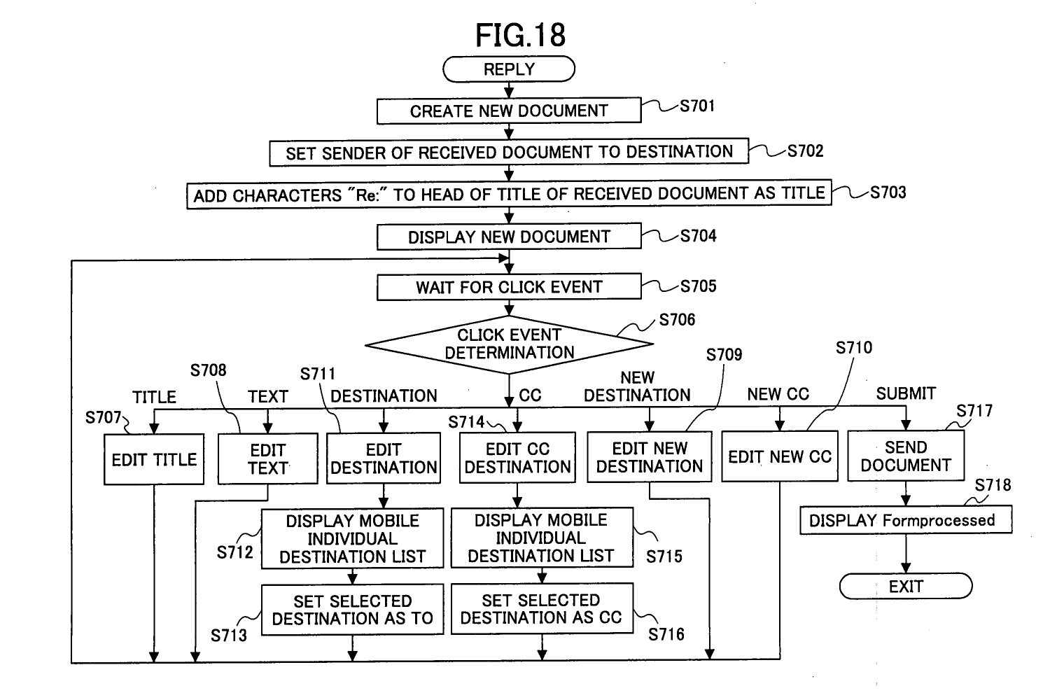

The “reply” process of step S506, that is, the procedure of a process in the case where “reply” is selected among the displayed contents of FIG. 27E, is as shown in FIG. 18.

First, a new document for reply is created (S701). The sender of the received document is set to the destination of the new document (S702), characters “Re:” are added to the head of the title of the received document as the title of the new document (S703), and the new document is displayed. (S704).

A click even is waited for (S705), and when a click event occurs, the contents thereof are determined (S706). In the case where the click event is “title”, a title editing process is performed (S707). In the case of “text”, an editing process of the text of the document is performed (S708). In the case of “new destination”, editing of new destination is performed (S709). In the case of “new CC”, an editing process of new CC (carbon copy) is performed (S710). After each process, the process returns to S705.

When the click event determined in step S706 is “destination”, a destination edit process is performed (S711). On this occasion, a list of mobile individual destinations (individual address book) is displayed (S712). A selected destination is set to “TO” (S713). Then, the process returns to S705.

When the click event is “CC”, a CC destination edit process is performed (S714). On this occasion, the list of mobile individual destinations (individual address book) is displayed (S715). A selected destination is set to “CC” (S716). Then, the process returns to step S705. When the click event is “SUBMIT”, a relevant new document is sent (S717), “Formprocessed” is displayed, and the reply process ends (S718).

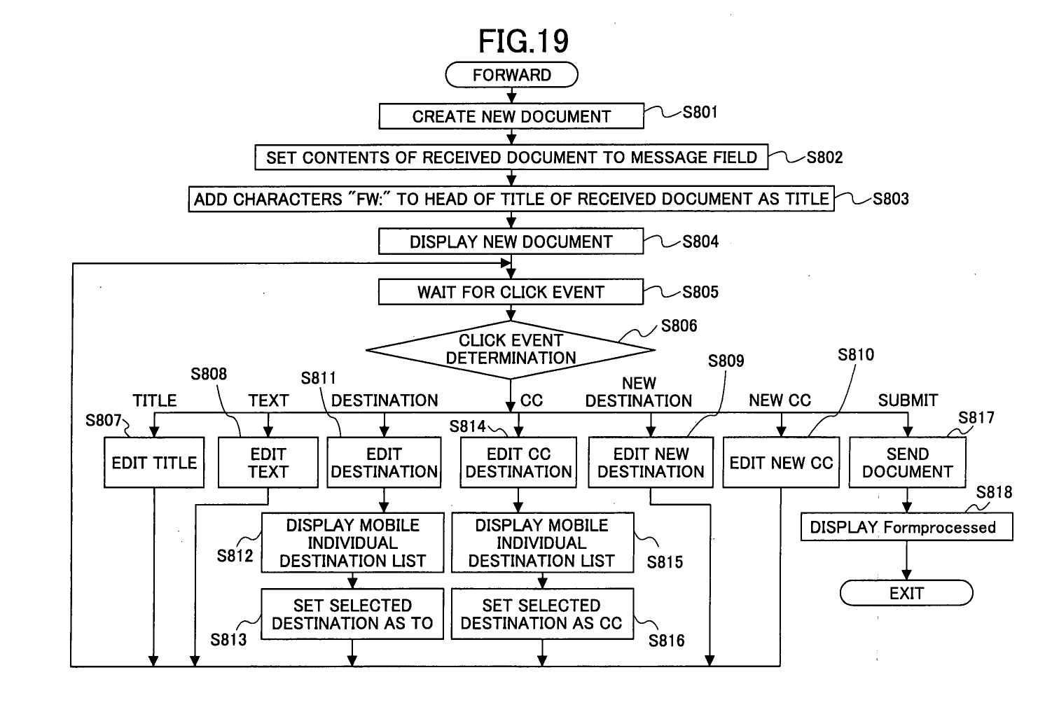

The procedure in the case where the “forward” process of step S507, that is, “forward” is selected in the display of FIG. 27E, is as shown in FIG. 19. The process (S801 through S818) is generally similar to that in the case of FIG. 17, but is different only in that the characters “FW:” are added to the head of the title of a received document to form a title.

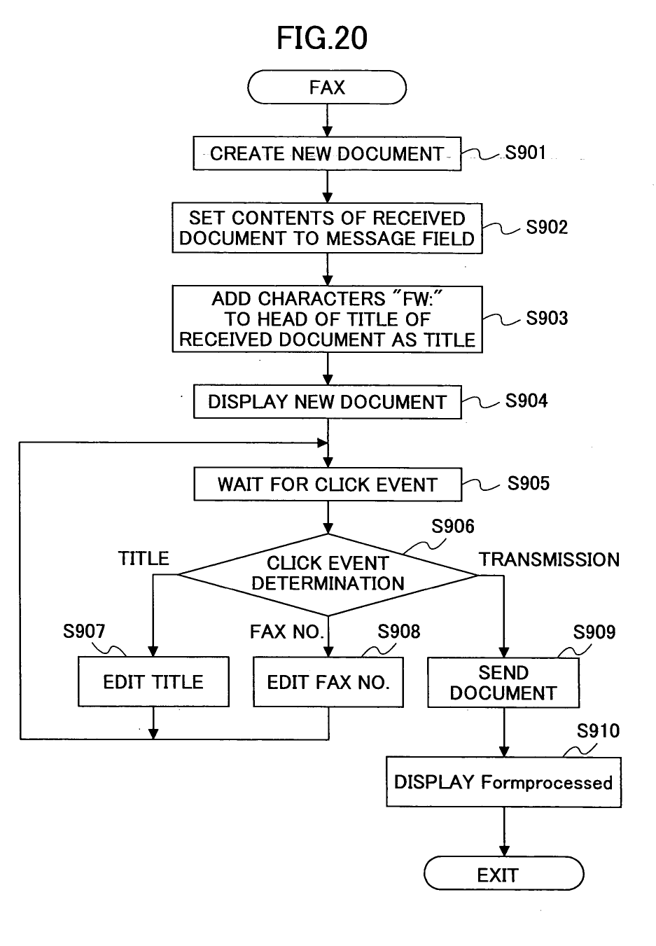

The procedure in the case where the “FAX” process of step S508, that is, “FAX” is selected in the displayed contents of FIG. 27E, is as shown in FIG. 20.

First, a new document for FAX is created (S901). The contents of the received document are set to the message field of the new document (S902), and the characters “FW:” are added to the head of the title of the received document to form a title (S903), and the new document is displayed (S904). Occurrence of a click event is waited for (S905), and when a click event occurs, the contents thereof are determined (S906). When the click event is “title”, a title edit process is performed (S907), and when “FAX number”, a FAX number edit process is performed (S908). After each process ends, the process returns to S905. When the click event is “transmission”, a relevant new document is sent (S909), “Formprocessed” is displayed, and a FAX data transmission process ends (S910).

The data thus transmitted are FAX printed at the destination of a FAX number. It should be noted that the above-mentioned FAX printing may be realized as one of the functions of a DOMINO engine, or may be realized by separately installing an application program for FAX printing in the host server 10 and activating the application program as needed.

Transmission Process

Next, a description is given of the transmission process of step S308.

In the transmission process, a new document for transmission is created as shown in FIG. 21 (S1001), and the new document is displayed in the display part (S1002). The process thereafter (S1003 through S1016) is similar to the procedure of steps S707 through S718 of the reply process shown in FIG. 18. However, the displayed contents of the display part of the mobile phone are varied as shown in FIG. 27F.

Search Process

Next, a description is given of the search process of step S309 of FIG. 12.

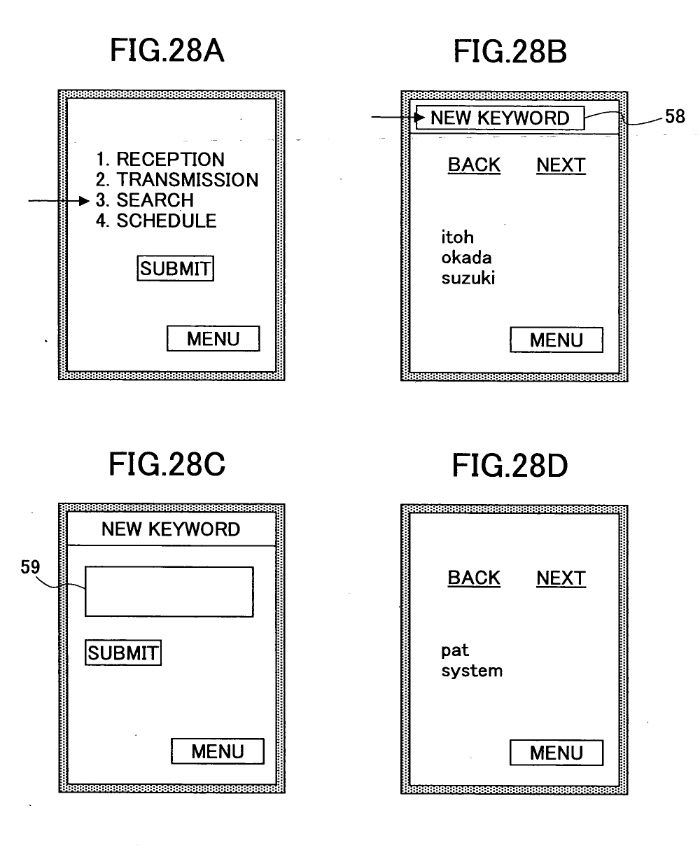

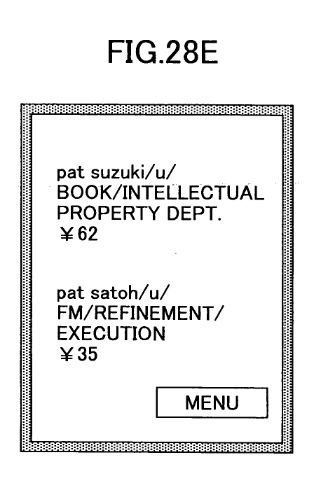

The search process is performed when the user selects “search” as shown in FIG. 28A. In this process, as shown in FIG. 22, first, data in a search view are sorted in alphabetically ascending order, and 10 sets of data are selected (S1011). Then, a search list is displayed in a list display area (S1102).

Occurrence of a click event is waited for (S1103), and when a click event occurs, the contents thereof are determined (S1104).

When the click event is “next”, +10 data items from the 10th data item of a page that is being displayed are set (S1105). Then, the set amount of data is selected. When there are less than 10 data items, only existing data are selected (S1106). Then, the process returns to S1102.

When the click event is “back”, −10 data items from the 1st data item of the page that is being displayed are set (S1107). Then, the set amount of data is selected. When there are no data items, the data of the current page are selected again (S1108). Then, the process returns to S1102.

When the click event is “display search list”, the contents of the display part of the mobile phone are varied from FIG. 28A to a list of keywords that have been searched for in the past. FIG. 28B shows such a condition. In FIG. 28B, “itoh”, “okada” and “suzuki” are keywords that have been searched for.

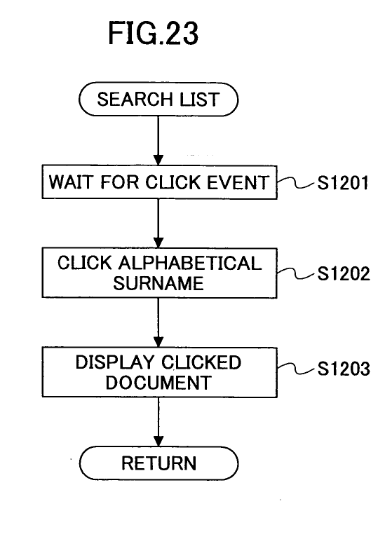

The procedure of the search list display process is as shown in FIG. 23. That is, occurrence of a click event is waited for (S1201), and when it is detected that an alphabetical surname (for example, “itoh”) is clicked, all documents including the clicked surname are displayed (S1202, S1203).

When the click event is “new keyword”, the search process by a new keyword is performed. On this occasion, the displayed contents of the display part are varied to a new keyword input screen as shown in FIG. 28C.

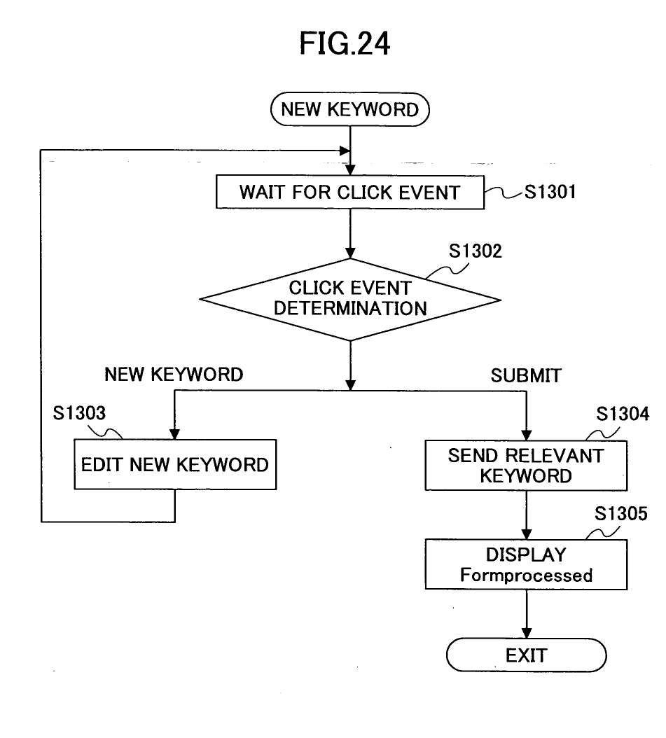

The process in this case is, as shown in FIG. 24, occurrence of a click event is waited for (S1301), and when a click event occurs, the contents thereof are determined (S1302). When the click event is “new keyword”, editing of a new keyword is performed (S1303), and the process returns to S1301. When the click event is “SUBMIT”, the relevant keyword is sent (S1304), “Formprocessed” is displayed, and the process ends (S1305). When a search result is transmitted from the host server 10, the process makes the transition to the search list display process accordingly. The screen of the display part is varied as shown in FIG. 28D. When a set of alphabets (for example, pat) is clicked, all documents including “pat” are displayed as shown in FIG. 28E.

Scheduling Process

Next, a description is given of the scheduling process of step S310 of FIG. 12.

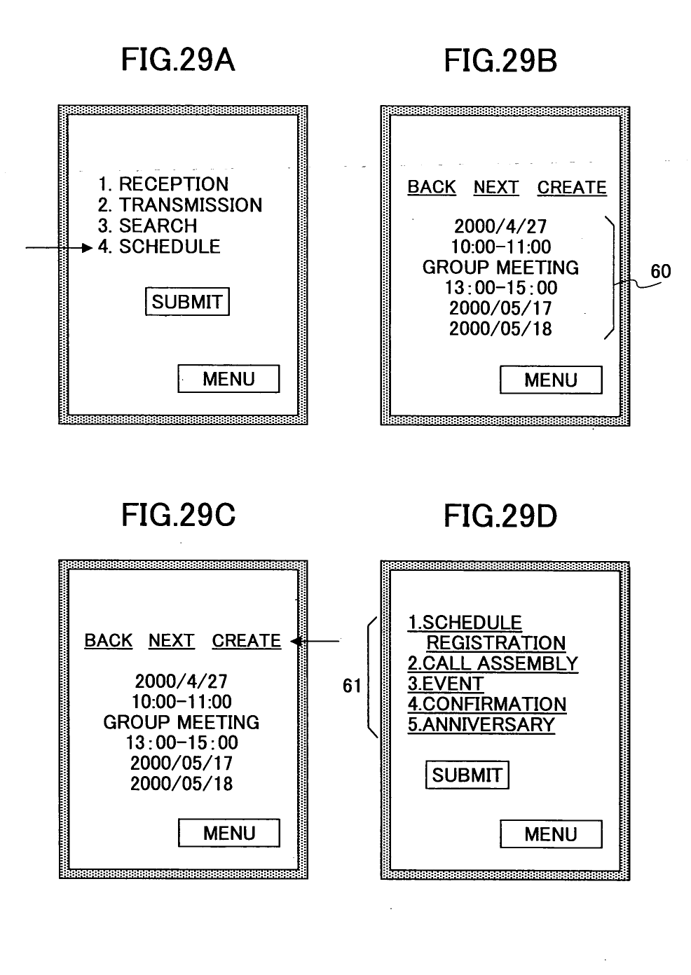

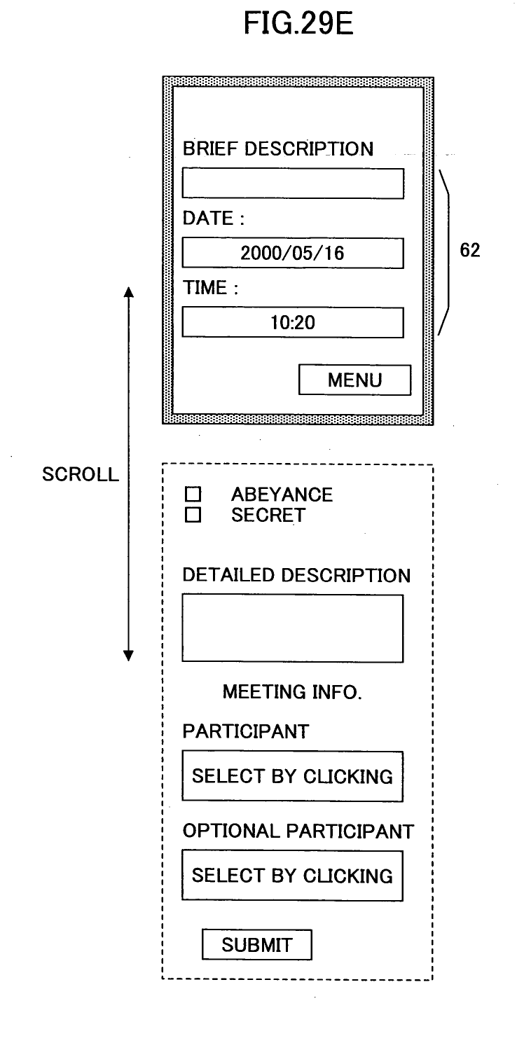

The scheduling process is performed when the user selects “schedule” as shown in FIG. 29A. In this process, as shown in FIG. 25, first, data in a schedule view are sorted in descending order by date, and 10 sets of data are selected (S1401). Then, a schedule list is displayed in the list display area of the display part (S1402). FIG. 29B is an example of a list display area 60, and showing the condition where, by clicking a certain date, a period of time and a brief description, which are set to the date, are displayed. Areas for selecting the events of “back”, “next” and “create” are formed in the upper part of the display part.

Occurrence of a click event is waited for (S1403), and when a click event occurs, the contents thereof are determined (S1404).

When the click event is “next”, +10 data items from the 10th data item of a page that is being displayed are set (S1405). Then, the set amount of data is selected. When there are less than 10 sets of data, only existing data are selected (S1406). Then, the process returns to step S1402.

When the click event is “back”, −10 data items from the 10th data item of the page that is being displayed are set (S1407). Then, the set amount of data is selected. When there are no data items, the data of the current page are selected again (S1408). Then, the process returns to S1402.

It should be noted that only data of “date of today” and later are objects of data in the schedule view. That is, those scheduled on or after the relevant date are extracted from the schedule file 107, and they are made visible on the mobile phone in the form of a list (View in a DOMINO server). In the aforementioned manner, it is possible to prevent data relating to past schedules from being recorded in the mobile phone, and thus it is possible to effectively use the memory of the mobile phone.

Those data relating to schedules of the dates before the current date and time before the current time may be automatically deleted from the schedule file 107 of the host server 10. In this case, unnecessary data are sequentially deleted from the schedule file 107 (the same applies to that of the local server 20). Hence, there are advantages in that it is possible to effectively use the memory area of the host server 10 (the same applies to the local server 20), and leakage of interoffice information is positively prevented.

When the click event is “create new”, that is, “create” is selected in the displayed contents of FIG. 29C, the process makes the transition to a creation process of a new schedule list. FIG. 26 is a procedure diagram of the creation process. In this process, first, a schedule creation menu is displayed (S1501). As shown in FIG. 29D, a selection area 61, including schedule registration, call assembly, event, confirmation and anniversary, is formed in the schedule creation menu. The user can arbitrarily select any of them.

Occurrence of a click event is waited for (S1502), and when a click event occurs, the contents thereof are determined (S1503).

When a specific menu is selected from the selection area 61, data input and editing are performed (S1504), and the process returns to step S1502. When the click event is “SUBMIT”, the input data are transmitted (S1505), “Formprocessed” is displayed, and the process ends (S1506). FIG. 29E is a diagram showing content examples of a data input area 62 in the case where “2. call assembly” is selected. A brief description and a time are associated with each date. It should be noted that the data input area 62 can be scrolled.

The data thus input are reflected to the schedule file 107 of the host server 10, and also reflected to the local server 20.

Further, a so-called “To Do List” function, that is, a function of managing tasks to be done and tasks that are done, may be performed upon an operation with respect to the mobile phone, as a part of the scheduling process or a separate process from the scheduling process. In this case, it is possible to readily realize such a configuration by adding on an application program to a standard scheduler function of “DOMINO server R5”.

As mentioned above, in the interoffice mailing system, it is possible to access the interoffice information, which is managed by the host server 10, from the mobile phone at any time and any place. There are a variety of modes for making accesses as described above, as if accesses are made from a fixed terminal in the intranet LN or a client terminal of the local server 20. The interoffice information of the host server 10 is common with that of the local server 20, which is connected thereto via the private circuit network PN. Hence, it is possible to indirectly perform communications with those connected to a network to which the local server 20 belongs, and thus it is possible to effectively operate the groupware.

It should be noted that when the receiving process, the transmission process, the search process, the scheduling process or the like is performed in the system, information transmitted from the host server 10 to the mobile phone is monitored by the transmission information management part 32f. The monitoring is performed by, for example, extracting by the transmission information management part 32f the URL of a page that is browsed by the user. By extracting such information, the transmission information management part 32f generates transmission information, which is information regarding what information is transmitted from the host server 10 to the mobile phone, that is, what page is browsed by the user, and records the transmission information in the transmission information recording part 32g. The recording of the transmission information is performed for each mobile phone, and the transmission information is recorded in the transmission information recording part 32g in such a manner that a corresponding mobile phone becomes clear.

The transmission information may be used as data for charging each mobile phone.

Additionally, in order to reduce the burden on the user in accessing the host server 10, the transmission information may be used as follows. That is, the transmission information is used in order to display a menu screen on the display of the mobile phone. In this case, when there is an access request and the mobile phone that issues the access request is determined to be valid, the following process may be performed, for example. First, among the recorded transmission information, the transmission information with respect to the mobile phone that issues the access request is read from the transmission information recording part 32g and transmitted to the control part 32a by the transmission information management part 32f. Subsequently, the control part 32a, which receives the transmission information, generates data for displaying a predetermined image on the display of the mobile phone, and transmits the data to the mobile phone via the input/output part 31. Based on the data, a predetermined menu image is displayed on the display of the mobile phone. The menu image to be displayed is similar to that of FIG. 29A, but the menu displayed therein is different for each mobile phone.

Application 2: Remote Operation System of Application

A network system according to the present invention may be applied as a remote operations system of an application instead of the interoffice mailing system or together with the interoffice mailing system.

The structure in this case is fundamentally similar to that in the case of the interoffice mailing system. However, there are differences: such as predetermined application programs, for example, a search program for performing an information search on an external database, which is not the common file, a print program for automatically printing specific information in the common file, and an automatic control program for interoffice business equipment; and that, in a Web mail screen displayed on the display part of the mobile phone, an operations image for activating an application program is formed on a browser screen or a dedicated command input is enabled.

Upon operation, a user who carries a mobile phone makes an access request to the host server 10 by, for example, selecting the operations image on the browser screen. The host server 10 interprets the contents of a command corresponding to the access request, notifies the local server 20 of the contents of the command, and activates and executes a relevant application program.

After the application program is executed, the host server 10 obtains information of the execution result form the local server 20, and also communicates the obtained information to the mobile phone.

In the aforementioned manner, in addition to sending and receiving of interoffice information, it is possible to externally and remotely activate an interoffice application program by a mobile phone. Hence, it is possible to readily build an interoffice network system with rich extensibility.

In this embodiment, it is assumed that the network forming the housing is the intranet LN. However, any form of network may be used as long as the network can be protected by a firewall. A normal local network may also form the housing. In addition, the description has been given by assuming that the mobile phone access request passes through the firewall 11 in one preferred embodiment. However, it is also possible to let an access from a wired mobile terminal via the Internet IN, that is, an access from a notebook computer or a PDA via a wired communication network, to pass through the firewall 11 under given conditions. In this case, however, since accesses from unspecified users connected to the Internet IN are allowed, it is necessary to pay attention to the point that the burden on the firewall 11 is increased.

As is clear from the above description, according to the present invention, it is possible to positively prevent “posing”. Hence, it becomes possible to readily built an environment for realizing dedicated groupware ensuring security.

The present invention is not limited to the specifically disclosed embodiments, and variations and modifications may be made without departing from the scope of the present invention.

1. An authentication apparatus that performs, when a user terminal used by a user assigned with predetermined user identification information accesses predetermined information, authentication as to whether the user terminal is valid based on terminal identification information assigned to each user terminal, said apparatus comprising:
user identification information recording means recording the user identification information therein;
user identification information determination means for receiving from the user terminal the user identification information of the user using the user terminal, and comparing the received user identification information with user identification information recorded in the user identification information recording means so as to determine whether the received user identification information is valid;
terminal identification information generation means for, when the received user identification information is determined to be valid, generating the terminal identification information to be recorded in the user terminal, and transmitting the generated terminal identification information to the user terminal;
terminal identification information recording means for recording the terminal identification information;
authentication means for comparing the terminal identification information received when the user terminal accesses the predetermined information with the terminal identification information recorded in the terminal identification information recording means so as to determine whether the received terminal identification information is valid; and
allowing means for, when the received terminal identification information is valid, allowing the access from the user terminal.

2. The authentication apparatus as claimed in claim 1, wherein the terminal identification information recording means records the terminal identification information and area information in pairs, the area information indicating an area of information accessible by a user terminal indicated by each terminal identification information, and
the allowing means allows the user terminal to make an access within an area indicated by the area information.

3. The authentication apparatus as claimed in claim 2, wherein the area information includes an address of an access destination registered in advance for each user terminal.

4. The authentication apparatus as claimed in claim 2, wherein the area information is a pair of an address and the user identification information.

5. The authentication apparatus as claimed in claim 2, wherein a single pair of an ID and a password is associated with one of the user identification information, and the single pair of an ID and a password is assigned as general ID and password in the case where the access destination is more than one.

6. The authentication apparatus as claimed in claim 5, further comprising means for collectively suspending or canceling suspension of use of the general ID and password.

7. The authentication apparatus as claimed in claim 6, further comprising:
means for recording an e-mail address used by each user by associating the e-mail address with the user identification information assigned to each user;
means for, when transmitting the terminal identification information to a user, reading an e-mail address assigned to the user from the means for recording an e-mail address, and transmitting to the e-mail address an e-mail including information for causing the user to transmit acknowledge information for confirming whether a predetermined process for causing transmission of the terminal identification information is performed by the user; and
means for, based on the acknowledge information received from the user who receives the e-mail, determining whether the predetermined process for causing transmission of the terminal identification information is performed by the user, and, performing one of: a process of canceling suspension of use of the general ID and password when it is determined that the transmission of the terminal identification information is based on an action of the user; and a process of suspending the use of the general ID and password when it is determined that the transmission of the terminal identification information is not based on an action of the user.

8. The authentication apparatus as claimed in claim 7, further comprising:
means for receiving the authentication information transmitted by the user in a form of an e-mail;
means for detecting an e-mail address of a transmitting source of the received acknowledge information, and comparing the e-mail address with the e-mail address recorded in the means for recording an e-mail address; and
means for performing, as a result of the comparison, one of: a process of canceling suspension of use of the general ID and password when the e-mail addresses match; and a process of suspending the use of the general ID and password when the e-mail addresses do not match.

9. The authentication apparatus as claimed in claim 7, further comprising:
means for recording a telephone number of a mobile phone used by each user by associating the telephone number with the user identification information assigned to each user;
means for receiving the authentication information transmitted by the user in a form of communication by telephone;
means for detecting a telephone number of a transmitting source of the received acknowledge information, and comparing the telephone number with the telephone number recorded in the means for recording a telephone number; and
means for performing, as a result of the comparison, one of: a process of canceling suspension of use of the general ID and password when the telephone numbers match; and a process of suspending the use of the general ID and password when the telephone numbers do not match.

10. The authentication apparatus as claimed in claim 1, wherein the user identification information consists of a pair of an ID and a password assigned to each user.

11. The authentication apparatus as claimed in claim 1, wherein a single pair of an ID and a password is associated with one of the user identification information, and the single pair of an ID and a password is assigned as general ID and password in the case where the access destination is more than one.

12. The authentication apparatus as claimed in claim 11, further comprising means for collectively suspending or canceling suspension of use of the general ID and password.

13. The authentication apparatus as claimed in claim 12, further comprising:
means for recording an e-mail address used by each user by associating the e-mail address with the user identification information assigned to each user;
means for, when transmitting the terminal identification information to a user, reading an e-mail address assigned to the user from the means for recording an e-mail address, and transmitting to the e-mail address an e-mail including information for causing the user to transmit acknowledge information for confirming whether a predetermined process for causing transmission of the terminal identification information is performed by the user; and
means for, based on the acknowledge information received from the user who receives the e-mail, determining whether the predetermined process for causing transmission of the terminal identification information is performed by the user, and, performing one of: a process of canceling suspension of use of the general ID and password when it is determined that the transmission of the terminal identification information is based on an action of the user; and a process of suspending the use of the general ID and password when it is determined that the transmission of the terminal identification information is not based on an action of the user.

14. The authentication apparatus as claimed in claim 13, further comprising:
means for receiving the authentication information transmitted by the user in a form of an e-mail;
means for detecting an e-mail address of a transmitting source of the received acknowledge information, and comparing the e-mail address with the e-mail address recorded in the means for recording an e-mail address; and
means for performing, as a result of the comparison, one of: a process of canceling suspension of use of the general ID and password when the e-mail addresses match; and a process of suspending the use of the general ID and password when the e-mail addresses do not match.

15. The authentication apparatus as claimed in claim 13, further comprising:
means for recording a telephone number of a mobile phone used by each user by associating the telephone number with the user identification information assigned to each user;
means for receiving the authentication information transmitted by the user in a form of communication by telephone;
means for detecting a telephone number of a transmitting source of the received acknowledge information, and comparing the telephone number with the telephone number recorded in the means for recording a telephone number; and
means for performing, as a result of the comparison, one of: a process of canceling suspension of use of the general ID and password when the telephone numbers match; and a process of suspending the use of the general ID and password when the telephone numbers do not match.

16. The authentication apparatus as claimed in claim 1, further comprising:
means for maintaining a program for causing the user terminal to be authenticated to transmit the terminal identification information thereof; and
means for transmitting the program to the user terminal requesting for authentication.

17. The authentication apparatus as claimed in claim 16, wherein the user terminal includes means for recording the program, and the terminal identification information is transmitted from the user terminal requesting for authentication by a function formed by activating the program recorded in the means for recording the program.

18. The authentication apparatus as claimed in claim 1, wherein the user terminal is a wireless mobile terminal.

19. The authentication apparatus as claimed in claim 1, wherein the information which the user terminal desires to access is record information of a common file that exists in a predetermined network requiring security, and at least a part of which common file is maintained to be common with a file existing outside the network.

20. A network system, comprising:
a first server recording information accessible to a user terminal therein; and
an authentication apparatus performing authentication as to whether the user terminal that desires to access the information recorded in the first server is valid,
the first server being configured to search for relevant information in response to an access from a valid user terminal and transmit the searched for information to the user terminal that is a source of the access;
the authentication apparatus including:
user identification information recording means recording therein predetermined user identification information assigned to a user;
user identification information determination means for receiving from the user terminal the user identification information of the user using the user terminal, and comparing the received user identification information with user identification information recorded in the user identification information recording means so as to determine whether the received user identification information is valid;
terminal identification information generation means for, when the received user identification information is determined to be valid, generating the terminal identification information to be recorded in the user terminal, and transmitting the generated terminal identification information to the user terminal;
terminal identification information recording means for recording the terminal identification information;
authentication means for comparing the terminal identification information received when the user terminal accesses the predetermined information with the terminal identification information recorded in the terminal identification information recording means so as to determine whether the received terminal identification information is valid; and
allowing means for, when the received terminal identification information is valid, allowing the access from the user terminal.

21. The network system as claimed in claim 20, wherein the first server is connected in a network to a second server via a private line or a virtual private line, the second server existing outside the network,
the first server and the second server include common files, at least a part of record information of the common files being maintained to be common with each other, and
the authentication apparatus performs authentication as to whether a user terminal that desires to access the record information of the common files of the first server is valid.

22. The network system as claimed in claim 21, wherein each of the first server and the second server is configured to transmit, when the record information of the common file thereof is changed, difference data before and after the change to the other server, and when the difference data are received from the other server, automatically perform a replication task that replicates the difference data to the common file thereof.

23. The network system as claimed in claim 21, wherein the number of the first servers is more than one, and the second server is provided such that each second server corresponds to one of the first servers.

24. The network system as claimed in claim 20, wherein the authentication apparatus further comprises: extracting means for extracting information transmitted from the first server to the user terminal; and transmission information recording means for recording, for each user terminal, data regarding transmission information indicating what information is transmitted.

25. The network system as claimed in claim 20, wherein the authentication apparatus further comprises transmission information presenting means for generating data for displaying transmission information with respect to the user terminal on a display of the user terminal based on the data recorded in the transmission information recording means.

26. A network system, comprising:
means for enabling a first server recording information accessible to a user terminal to perform communications within a predetermined network; and
an authentication apparatus performing authentication as to whether a user terminal that desires to access the information via the network is valid,
the first server being configured to search for relevant information in response to an access from a valid user terminal and transmit the searched for information to the user terminal that is a source of the access,
the authentication apparatus comprising:
user identification information recording means recording the user identification information therein;
user identification information determination means for receiving from the user terminal the user identification information of the user using the user terminal, and comparing the received user identification information with user identification information recorded in the user identification information recording means so as to determine whether the received user identification information is valid;
terminal identification information generation means for, when the received user identification information is determined to be valid, generating the terminal identification information to be recorded in the user terminal, and transmitting the generated terminal identification information to the user terminal;
terminal identification information recording means for recording the terminal identification information;
authentication means for comparing the terminal identification information received when the user terminal accesses the predetermined information with the terminal identification information recorded in the terminal identification information recording means so as to determine whether the received terminal identification information is valid; and
allowing means for, when the received terminal identification information is valid,
allowing the access from the user terminal.

27. A method of authenticating a user terminal in a network system,
wherein an authentication apparatus is provided in a network system in which a first server recording information accessible to a user terminal exists in a predetermined network, and the authentication apparatus performs authentication as to whether a user terminal that desires to access the information is valid,
the authentication apparatus
records user identification information assigned in advance to a user;
receives from the user terminal requesting for authentication the user identification information of the user using the user terminal, and when the received user identification information matches any user identification information that is already recorded, determines that the user terminal is valid and generates terminal identification information to be recorded in the user terminal;
records and transmits the generated terminal identification information to the user terminal; and
compares the terminal identification information received when the user terminal accesses predetermined information with the terminal identification information recorded in the apparatus so as to determine whether the received terminal identification information is valid, and when the received terminal identification information is valid, allows the access from the user terminal.

28. A computer program for causing a computer to perform processes, the computer being provided in a network system in which a first server recording information accessible to a user terminal exists in a predetermined network, and the first server searches for relevant information in response to a request from a valid user terminal and transmits the searched for information to the user terminal,
the processes comprising:
(1) a process of recording predetermined user identification information assigned in advance to a user;
(2) a process of receiving from the user terminal requesting for authentication at least the user identification information of the user using the user terminal, and when the received user identification information matches any user identification information that is already recorded, determining that the user terminal is valid and generating terminal identification information to be recorded in the user terminal;
(3) a process of recording and transmitting the generated terminal identification information to the user terminal; and
(4) a process of comparing the terminal identification information received when the user terminal accesses predetermined information with the terminal identification information recorded in the apparatus so as to determine whether the received terminal identification information is valid; and
(5) a process of allowing, when the received terminal identification information is valid, the access from the user terminal.
